(19) United States
(12) Patent Application Publication
(10) Pub. No.: US 2024/0296856 A1
(43) Pub. Date: Sep. 5, 2024

(54) AUDIO DATA PROCESSING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Daiyu HUANG, Shenzhen (CN); Feng BAO, Shenzhen (CN); Yuepeng LI, Shenzhen (CN)

(21) Appl. No.: 18/646,448

(22) Filed: Apr. 25, 2024

Related U.S. Application Data
(63) Continuation of application No. PCT/CN2023/108796, filed on Jul. 24, 2023.

(30) Foreign Application Priority Data
Sep. 13, 2022 (CN) 202211110666.3

(51) Int. Cl. G10L 21/0264; G10L 21/0232; G10L 25/18; G10L 25/21; G10L 25/24

(52) U.S. Cl. CPC G10L 21/0264; G10L 21/0232; G10L 25/18; G10L 25/21; G10L 25/24

(57) ABSTRACT

This application discloses an audio data processing method. The method includes obtaining a target audio data frame and K historical audio data frames that are associated with raw audio data, and K being a positive integer; in a case that N target cepstrum coefficients of the target audio data frame are obtained, obtaining, M first-order time derivatives and M second-order time derivatives, N being a positive integer greater than 1, and M being a positive integer less than N; obtaining N historical cepstrum coefficients, and determining a dynamic spectrum feature associated with the target audio data frame; and inputting the N target cepstrum coefficients, the M first-order and second-order time derivatives, and the dynamic spectrum feature into a target mask estimation model to obtain a target mask; and applying the target mask to obtain enhanced audio data by suppressing noise data in the raw audio data.

### RELATED APPLICATIONS

This application is a continuation of PCT Application No. PCT/CN2023/108796, filed on Jul. 24, 2023, which claims priority to Chinese Patent Application No. 202211110666.3, entitled “AUDIO DATA PROCESSING METHOD AND APPARATUS, AND READABLE STORAGE MEDIUM” filed with the China National Intellectual Property Administration on Sep. 13, 2022, which is incorporated herein by reference in its entirety.

### FIELD OF THE TECHNOLOGY

This application relates to the field of computer technologies, and in particular, to an audio data processing method and apparatus, a device, a storage medium, and a program product.

### BACKGROUND OF THE DISCLOSURE

Currently, audio data needs to be captured in some audio/video capture service scenarios (for example, an audio/video conference scenario). However, the captured audio data is very likely to include non-stationary noise, which interferes with the target speech in the current audio data. Consequently, the quality of the captured target speech is reduced.

The non-stationary noise includes non-stationary babble noise that is associated with speaking by a plurality of speakers. Components of noise data of the non-stationary babble noise are similar to those of speech data of the target speech. Therefore, during speech enhancement on the target speech that includes the non-stationary babble noise, speech data, in the target speech, that includes speech components similar to those of the non-stationary babble noise is likely to be mistakenly eliminated. This reduces speech fidelity obtained after noise suppression is performed on the audio data.

### SUMMARY

Embodiments of this application provide an audio data processing method and apparatus, a device, a storage medium, and a program product, to effectively suppress noise data in audio data and improve speech fidelity.

According to an aspect, embodiments of this application provide an audio data processing method, performed by a computer device and including:

obtaining a target audio data frame and K historical audio data frames that are associated with raw audio data, the target audio data frame and the K historical audio data frames being spectral frames, each of the K historical audio data frames being a spectral frame preceding the target audio data frame, and K being a positive integer; in a case that N target cepstrum coefficients of the target audio data frame are obtained, obtaining, based on the N target cepstrum coefficients, M first-order time derivatives and M second-order time derivatives that are associated with the target audio data frame, N being a positive integer greater than 1, and M being a positive integer less than N; obtaining N historical cepstrum coefficients corresponding to each historical audio data frame, and determining, based on obtained K×N historical cepstrum coefficients, a dynamic spectrum feature associated with the target audio data frame; and inputting the N target cepstrum coefficients, the M first-order time derivatives, the M second-order time derivatives, and the dynamic spectrum feature into a target mask estimation model to obtain a target mask corresponding to the target audio data frame; and applying the target mask to obtain enhanced audio data corresponding to the raw audio data by suppressing noise data in the raw audio data.

According to an aspect, embodiments of this application provide an audio data processing method, performed by a computer device and including:

obtaining a target sample audio data frame and K historical sample audio data frames that are associated with sample audio data, and obtaining a sample mask corresponding to the target sample audio data frame, the target sample audio data frame and the K historical sample audio data frames being spectral frames, each of the K historical sample audio data frames being a spectral frame preceding the target sample audio data frame, and K being a positive integer; in a case that N target sample cepstrum coefficients of the target sample audio data frame are obtained, obtaining, based on the N target sample cepstrum coefficients sample, M sample first-order time derivatives and M sample second-order time derivatives that are associated with the target sample audio data frame, N being a positive integer greater than 1, and M being a positive integer less than N; obtaining N historical sample cepstrum coefficients corresponding to each historical sample audio data frame, and determining, based on obtained K×N historical sample cepstrum coefficients, a sample dynamic spectrum feature associated with the target sample audio data frame; inputting the N target sample cepstrum coefficients, the M sample first-order time derivatives, the M sample second-order time derivatives, and the sample dynamic spectrum feature to an initial mask estimation model, the initial mask estimation model outputting a predicted mask corresponding to the target sample audio data frame; and performing iterative training on the initial mask estimation model based on the predicted mask and the sample mask to obtain a target mask estimation model, the target mask estimation model outputting a target mask corresponding to a target audio data frame associated with raw audio data, and the target mask being used for suppressing noise data in the raw audio data to obtain enhanced audio data corresponding to the raw audio data.

An aspect of the embodiments of this application provides a computer device, including: a processor and a memory,

the processor being connected to the memory, the memory being configured to store a computer program, and when the computer program is executed by the processor, the computer device being enabled to perform the method provided in embodiments of this application.

According to an aspect, embodiments of this application provide a non-transitory computer-readable storage medium, the computer-readable storage medium storing a computer program, and the computer program being suitable for being loaded and executed by a processor, so that a computer device having the processor performs the method provided in embodiments of this application.

### BRIEF DESCRIPTION OF THE DRAWINGS

To describe the technical solutions in embodiments of this application or in the related art more clearly, the following briefly describes the accompanying drawings for describing the embodiments or the related art. Apparently, the accompanying drawings in the following description show merely some embodiments of this application, and a person of ordinary skill in the art may still derive other drawings from the accompanying drawings without creative efforts.

FIG. 1 is a schematic diagram of a system architecture according to an embodiment of this application.

FIG. 2 is a schematic diagram of a scenario of audio data processing according to an embodiment of this application.

FIG. 3 is a schematic flowchart of an audio data processing method according to an embodiment of this application.

FIG. 4a is a schematic diagram of a scenario of audio preprocessing according to an embodiment of this application.

FIG. 4b is a schematic diagram of a scenario of audio preprocessing according to an embodiment of this application.

FIG. 5 is a schematic diagram of a scenario of a differential operation on cepstrum coefficients according to an embodiment of this application.

FIG. 6 is a schematic diagram of a scenario of obtaining an interframe difference value according to an embodiment of this application.

FIG. 7 is a schematic diagram of a network structure of a mask estimation model according to an embodiment of this application.

FIG. 8 is a schematic flowchart of an audio data processing method according to an embodiment of this application.

FIG. 9 is a schematic flowchart of model training according to an embodiment of this application.

FIG. 10 is a schematic diagram of noise reduction effect according to an embodiment of this application.

FIG. 11 is a schematic structural diagram of an audio data processing apparatus according to an embodiment of this application.

FIG. 12 is a schematic structural diagram of an audio data processing apparatus according to an embodiment of this application.

FIG. 13 is a schematic structural diagram of a computer device according to an embodiment of this application.

FIG. 14 is a schematic structural diagram of an audio data processing system according to an embodiment of this application.

### DESCRIPTION OF EMBODIMENTS

The technical solutions in embodiments of this application are clearly and completely described in the following with reference to the accompanying drawings in embodiments of this application. The described embodiments are merely some rather than all of embodiments of this application. All other embodiments obtained by a person of ordinary skill in the art based on the embodiments of this application without making creative efforts shall fall within the protection scope of this application.

Artificial intelligence (AI) refers to the theory, method, technology, and application systems that use a digital computer or a machine controlled by a digital computer to simulate, extend, and expand human intelligence, perceive an environment, obtain knowledge, and use the knowledge to obtain an optimal result. AI is directed to studying design principles and implementation methods of various intelligent machines, and enabling the machines to have functions of perception, reasoning, and decision-making.

Speech enhancement (SE) technology is a technology of extracting a wanted speech signal from noisy background to suppress and reduce noise interference in a case that a speech signal is interfered with or even submerged in various types of noise. In speech enhancement technology, speech noise may be separated from non-speech noise to ensure intelligibility of speech. To be specific, raw speech as pure as possible is extracted from noisy speech.

Speech enhancement is applied to a wide range of fields, including voice calls, teleconferencing, real-time audio/video conferencing, scene recording, hearing-aid devices, speech recognition devices, and the like, and has become a preprocessing module of many speech coding and recognition systems.

Solutions provided in embodiments of this application relate to digital signal processing (DSP) technology. It can be understood that DSP is a technology of converting analog information (for example, audio, videos, or pictures) into digital information. In the DSP technology, a computer or a dedicated processing device is used to capture, transform, filter, estimate, enhance, compress, recognize, or perform other processing on a signal in a digital form, to obtain a signal form that meets people's needs. In embodiments of this application, the DSP technology may be used for extracting a target audio feature including a target cepstrum coefficient, a first-order time derivative, a second-order time derivative, and a dynamic spectrum feature from a target audio data frame.

Solutions provided in embodiments of this application further relate to machine learning (ML) technology in the AI field. ML is a multi-field inter-discipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML generally includes technologies such as an artificial neural network, a belief network, reinforcement learning, transfer learning, inductive learning, and learning from demonstrations. In embodiments of this application, a target mask estimation model is an AI model based on the ML technology, and may be used for estimating a corresponding mask from an input audio feature.

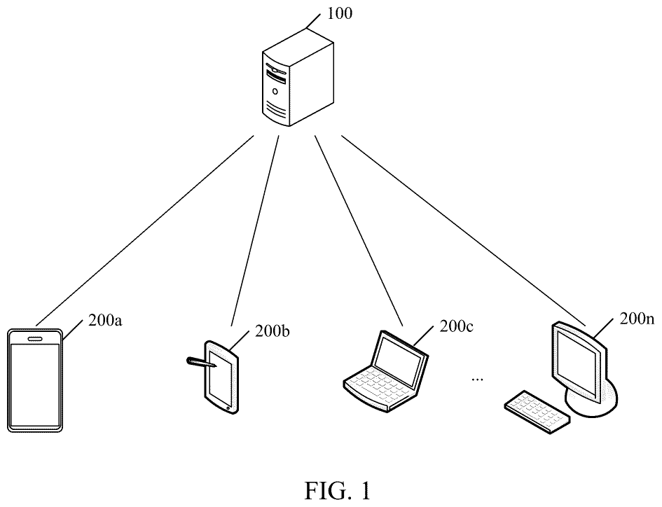

FIG. 1 is a schematic diagram of a system architecture according to an embodiment of this application. As shown in FIG. 1, the system architecture may include a service server 100 and a user terminal cluster. The user terminal cluster may include one or more user terminals. The quantity of user terminals in the user terminal cluster is not limited herein. As shown in FIG. 1, a plurality of user terminals in the user terminal cluster may specifically include a user terminal 200a, a user terminal 200b, a user terminal 200c, . . . , and a user terminal 200n.

The user terminals may be communicatively connected to each other. For example, user terminal 200a is communicatively connected to the user terminal 200b, and the user terminal 200a is communicatively connected to the user terminal 200c. In addition, any user terminal in the user terminal cluster may be communicatively connected to the service server 100, so that each user terminal in the user terminal cluster can exchange data with the service server 100 through the communication connection. For example, the user terminal 200a is communicatively connected to the service server 100. The connection mode of the communication connection is not limited. A direct or indirect connection may be established through wired communication or wireless communication or in another manner. This is not limited to this application.

It is to be understood that an application client may be installed on each user terminal in the user terminal cluster shown in FIG. 1. When running on each user terminal, the application client may exchange data with the service server 100 shown in FIG. 1. The application client may be a client with a function of displaying data information such as text, images, audio, and videos, for example, a social client, an instant messaging client (for example, a conferencing client), an entertainment client (for example, a game client or a livestreaming client), a multimedia client (for example, a video client), an information client (for example, a news client), a shopping client, an in-vehicle client, or a smart household client.

For example, in some embodiments, the application client may be a client with an audio/video communication function. The audio/video communication function herein may be a pure audio communication function or video communication function. The function may be widely used in a variety of service scenarios involving audio/video capture, for example, audio/video conferencing, audio/video calls, and audio/video livestreaming, in different fields such as enterprise office, instant communication, online education, remote medical, and digital finance. The application client may be an independent client, or an embedded sub-client integrated in a client (for example, a social client or a video client). This is not limited herein.

An instant messaging client is used as an example. The service server 100 may be a collection of a plurality of servers, including a background server and a data processing server that correspond to the instant messaging client. Therefore, each user terminal may perform data transmission with the service server 100 through the instant messaging client. For example, each user terminal may capture related audio/video data in real time and transmit the captured audio/video data to other user terminals through the service server 100, to implement audio/video communication (for example, remote real-time audio/video conferencing).

It is to be understood that, in various application scenarios (for example, a real-time audio/video communication scenario), audio data captured through an audio/video capture process is inevitably interfered with by external noise, especially noise including background voice (namely, babble noise). It is more difficult to eliminate interference caused by this type of noise to target speech in current audio data.

To improve the quality of captured target speech, this type of noise needs to be suppressed. Based on this, embodiments of this application provide a real-time noise suppression method for audio data. In this method, DSP is effectively combined with a neural network with a nonlinear fitting capability to suppress noise data (for example, babble noise) during audio/video communication while ensuring high speech fidelity.

DSP-based speech enhancement technologies may be further classified into a single-channel speech enhancement technology and a microphone array speech enhancement technology based on different quantities of channels. The DSP-based speech enhancement technology can well cope with stationary noise during real-time online speech enhancement, but has a poor capability of suppressing non-stationary noise. However, an ML/deep learning (DL)-based speech enhancement technology has exclusive characteristics in noise suppression. This technology can reduce highly non-stationary noise and background sound, and may be used commercially for real-time communication. Therefore, an effective combination of the DSP technology and the ML/DL technology can meet requirements for both non-stationary noise suppression and real-time communication.

It is to be understood that the non-stationary noise herein is noise whose statistical properties change over time, for example, barks, noise from kitchen utensils, babies' cries, and construction or traffic noise that are captured along with target speech during audio/video capture.

For ease of subsequent understanding and description, in embodiments of this application, source objects of target speech may be collectively referred to as a service object (for example, a user who makes a speech during audio/video communication, also referred to as a presenter), and to-be-processed audio data associated with the service object is collectively referred to as raw audio data.

It can be understood that the raw audio data herein may be obtained by an audio device by capturing sound in a real environment in which the service object is located, and may include both speech data (namely, speech data of target speech) produced by the service object and noise data in the environment.

In embodiments of this application, the noise data is noise data of non-stationary babble noise, and may include real talking (namely, babble noise) around the service object, songs or talking carried in a multimedia file that is being played, and other similar non-stationary babble noise.

The multimedia file herein may be a video file carrying both image data and audio data, for example, a short video, TV series, a movie, a music video (MV), or an animation; or may be an audio file mainly including audio data, for example, a song, an audio book, a radio play, or a radio program. The type, content, a source, and a format of the multimedia file are not limited in embodiments of this application.

In addition, in embodiments of this application, a neural network model for performing mask estimation on an audio feature extracted from raw audio data may be referred to as a target mask estimation model.

In some embodiments, the audio device may be a hardware component disposed in a user terminal. For example, the audio device may be a microphone of the user terminal. Alternatively, in some embodiments, the audio device may be a hardware apparatus connected to a user terminal, for example a microphone connected to the user terminal, to provide the user terminal a service of obtaining raw audio data. The audio device may include an audio sensor, a microphone, and the like.

It can be understood that the method provided in embodiments of this application may be performed by a computer device. The computer device includes but is not limited to a user terminal (for example, any user terminal in the user terminal cluster shown in FIG. 1) or a service server (for example, the service server 100 shown in FIG. 1). The service server may an independent physical server, or may be a server cluster or a distributed system that includes a plurality of physical servers, or may be a cloud server that provides basic cloud computing services such as a cloud database, a cloud service, cloud computing, a cloud function, cloud storage, a network service, cloud communication, a middleware service, a domain name service, a security service, a CDN, big data, and an artificial intelligence platform. The user terminal may be a smart terminal on which the foregoing application client can be run, for example, a smartphone, a tablet computer, a notebook computer, a desktop computer, a palmtop computer, a wearable device (for example, a smart watch, a smart wristband, a smart hearing-aid device), a smart computer, or a smart in-vehicle device. The user terminal and the service server may be directly or indirectly connected in a wired or wireless manner. This is not limited to embodiments of this application.

The user terminal 200a and the user terminal 200b are used as examples for description. It is assumed that a service object 1 performs audio/video communication with a service object 2 corresponding to the user terminal 200b through an application client on the user terminal 200a (for example, the service object 1 is in a voice-only conference with the service object 2). When the service object 1 is talking, the user terminal 200a may obtain raw audio data associated with the service object 1 through a related audio device (for example, a microphone in the user terminal 200a).

In embodiments of this application, the raw audio data may be a mixed audio signal in time domain. It is difficult to directly extract a pure speech signal from the mixed audio signal in time domain. Therefore, this application focuses on separation of speech in frequency domain.

Specifically, audio preprocessing may be performed on the raw audio data to obtain a plurality of spectral frames (also referred to as audio data frames in embodiments of this application) in frequency domain. Each spectral frame includes a part of a spectrum of the raw audio data in frequency domain. In some embodiments of this application, any to-be-processed spectral frame of the plurality of spectral frames may be referred to as a target audio data frame. Correspondingly, a spectral frame preceding the target audio data frame in frequency domain may be referred to as a historical audio data frame. In other words, the historical audio data frame is a spectral frame obtained before the target audio data frame.

Based on this, further, the user terminal 200a may obtain the target audio data frame and K historical audio data frames that are associated with the raw audio data, K being a positive integer. A specific quantity of historical audio data frames is not limited in embodiments of this application. The target audio data frame and the K historical audio data frames herein are spectral frames, and each of the K historical audio data frames is a spectral frame preceding the target audio data frame.

To improve accuracy and intelligibility of speech separation, a plurality of audio features is used for mask estimation in this application. The target audio data frame is used herein as an example for description. Processing processes for other spectral frames are the same as that for the target audio data frame. Specifically, the user terminal 200a may obtain N target cepstrum coefficients of the target audio data frame, and then may obtain, based on the N target cepstrum coefficients, M first-order time derivatives and M second-order time derivatives that are associated with the target audio data frame, N being a positive integer greater than 1, and M being a positive integer less than N. A specific quantity of target cepstrum coefficients, a specific quantity of first-order time derivatives, and a specific quantity of second-order time derivatives are not limited in embodiments of this application. In addition, the user terminal 200a may further obtain N historical cepstrum coefficients corresponding to each historical audio data frame, and may determine, based on obtained K×N historical cepstrum coefficients, a dynamic spectrum feature associated with the target audio data frame.

In embodiments of this application, a cepstrum coefficient, a first-order time derivative, a second-order time derivative, and a dynamic spectrum feature related to each spectral frame may be collectively referred to as an audio feature. An audio feature corresponding to the target audio data frame may be referred to as a target audio feature. It can be understood that the target cepstrum coefficient may be used for characterizing an acoustic feature of the target audio data frame, and a related first-order time derivative, second-order time derivative, and dynamic spectrum feature may be used for characterizing a feature of time correlation between audio signals (or a stability feature of audio signals). Therefore, the user terminal 200a may input the N target cepstrum coefficients, the M first-order time derivatives, the M second-order time derivatives, and the dynamic spectrum feature into a trained target mask estimation model, and the target mask estimation model outputs a target mask corresponding to the target audio data frame, The target mask may be used for suppressing noise data in the raw audio data to obtain enhanced audio data corresponding to the raw audio data.

To be specific, speech data and noise data in the raw audio data can be effectively separated by using an obtained mask corresponding to each spectral frame, to implement speech enhancement during audio/video communication. It can be understood that a mask obtained through modeling based on a plurality of audio features is more accurate. Therefore, speech fidelity of enhanced audio data obtained by using the mask is also high.

In embodiments of this application, the target mask may include but is not limited to an ideal ratio mask (IRM), an ideal binary mask (IBM), an optimal ratio mask (ORM), and the like. The type of the target mask is not limited herein.

It can be understood that the user terminal 200a may subsequently transmit the obtained enhanced audio data to the service server 100, and then the service server 100 delivers the enhanced audio data to the terminal device 200b. Correspondingly, it can be understood that, when service object 2 makes a speech, the terminal device 200b may also perform a speech enhancement process similar to that described above, to transmit, to the terminal device 200a, obtained enhanced audio data related to the service object 2. Accordingly, service object 1 and the service object 2 can always hear high-quality speech transmitted by each other during audio/video communication. This can implement high-quality audio/video communication and improve user experience.

In some embodiments, the application client may alternatively be a client with an audio/video editing function, and may perform speech enhancement on to-be-processed raw audio data by using the function. The function may be applied to service scenarios involving audio/video capture, for example, audio/video production or audio/video recording. The raw audio data may be obtained by an audio device by recording, in real time, sound in a real environment in which a service object (which may be a target user on which speech enhancement is to be performed) is located. Alternatively, the raw audio data may be obtained from a to-be-processed multimedia file (which may include a video file and an audio file). This is not limited to embodiments of this application. Similarly, the raw audio data may alternatively be a mixed audio signal that includes speech data of the service object and noise data in the environment in which the service object is located. The process of performing speech enhancement on the raw audio data is similar to the foregoing process of speech enhancement in the audio/video communication scenario. Clearer enhanced audio data that is finally obtained may be directly stored or transmitted, or may be used for replacing raw audio data in the to-be-processed multimedia file. Compared with the real-time audio/video communication scenario, the non-real-time audio/video editing scenario has a lower requirement for real-time performance of speech enhancement, but a requirement of a user for high-quality speech can still be met.

In some embodiments, the service server may also obtain the raw audio data transmitted by the user terminal, and obtain, by loading a trained target mask estimation model, a target mask corresponding to a target audio data frame associated with the raw audio data, to implement speech enhancement. The system architecture shown in FIG. 1 may include one or more service servers. One user terminal may be connected to one service server. Each service server may obtain raw audio data uploaded by a user terminal connected to the service server, and perform speech enhancement on the raw audio data.

It can be understood that the foregoing system architecture is suitable for a variety of service scenarios involving audio/video capture. The service scenarios may specifically include real-time noise reduction scenarios such as an audio/video conferencing scenario, an audio/video call scenario, an audio/video livestreaming scenario, an audio/video interview scenario, a remote visiting scenario, speech enhancement for a hearing-aid device, and speech recognition; or may be non-real-time noise reduction scenarios such as audio/video recording and audio/video post-production, or other service scenarios in which speech enhancement needs to be performed on captured audio data, especially a service scenario in which babble noise needs to be suppressed in real time. Specific service scenarios are not described in detail herein.

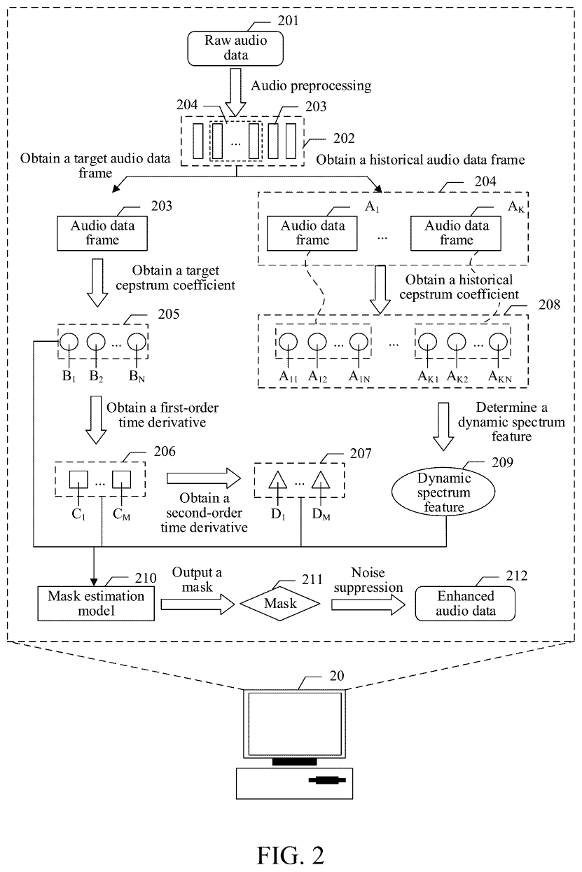

Referring to FIG. 2, FIG. 2 is a schematic diagram of a scenario of audio data processing according to an embodiment of this application. Computer device 20 shown in FIG. 2 may be the service server 100 or any user terminal (for example, the user terminal 200a) in the user terminal cluster in the embodiment corresponding to FIG. 1. This is not limited herein.

As shown in FIG. 2, raw audio data 201 may be a mixed audio signal that includes speech data of a service object and noise data in an environment. The raw audio data 201 may be audio data captured in real time by a related audio device of the computer device 20, or may be audio data obtained by the computer device 20 from a to-be-processed multimedia file, or may be audio data transmitted by another computer device to the computer device 20 for audio processing. This is not limited to embodiments of this application.

It can be understood that the computer device 20 may suppress the noise data in the raw audio data 201 after obtaining the raw audio data 201 to obtain audio data with higher speech quality. To achieve this objective, the computer device 20 may first extract an audio feature of the raw audio data 201 by using a DSP technology. Before this, the computer device 20 may perform audio preprocessing on the raw audio data 201, specifically including: performing framing and windowing preprocessing, time-frequency transform, or another operation on the raw audio data 201. Accordingly, an audio data frame set 202 associated with the raw audio data 201 can be obtained. The audio data frame set 202 may include a plurality of audio data frames in frequency domain (namely, spectral frames). The quantity of audio data frames included in the audio data frame set 202 is not limited herein.

Then the computer device 20 may perform audio feature extraction, mask estimation, noise suppression, or another processing operation on each audio data frame in the audio data frame set 202. A sequence of processing audio data frames is not limited to embodiments of this application. For example, a plurality of audio data frames may be processed in parallel, or the audio data frames may be processed in series according to a chronological order in which the audio data frames are obtained. In some embodiments of this application, any to-be-processed audio data frame in audio data frame set 202 may be used as a target audio data frame. For example, audio data frame 203 in the audio data frame set 202 may be used as the target audio data frame. In a case that another audio data frame is used as the target audio data frame, a corresponding processing process is the same as that for the audio data frame 203.

In addition, the computer device 20 may further obtain a historical audio data frame set 204 associated with the audio data frame 203 in the audio data frame set 202. The historical audio data frame set 204 may include K historical audio data frames preceding the target audio data frame. For example, the K historical audio data frames may be an audio data frames A₁, . . . , and an audio data frame A^{K} in sequence, K being a positive integer. A specific value of K is not limited herein. It can be understood that the audio data frame A₁ to the audio data frame A_{K} are spectral frames preceding the audio data frame 203.

Further, computer device 20 may perform audio feature extraction on the target audio data frame. The audio data frame 203 is used as an example. Computer device 20 may obtain a cepstrum coefficient set 205 corresponding to the audio data frame 203. The cepstrum coefficient set 205 may be used for characterizing an acoustic feature of the audio data frame 203. The cepstrum coefficient set 205 may include N target cepstrum coefficients of the audio data frame 203. For example, the N target cepstrum coefficients may specifically include a cepstrum coefficient B₁, a cepstrum coefficient B₂, . . . , and a cepstrum coefficient B_{N}, N being a positive integer greater than 1. A specific value of N is not limited herein.

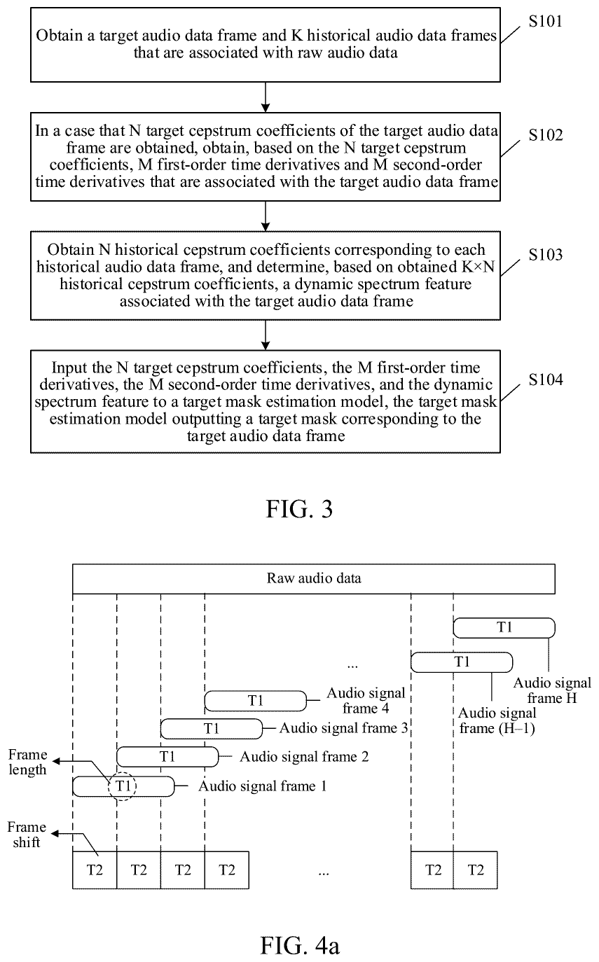

Then the computer device 20 may obtain, based on the N target cepstrum coefficients in the cepstrum coefficient set 205, M first-order time derivatives and M second-order time derivatives that are associated with the audio data frame 203, M being a positive integer less than N. A specific value of M is not limited herein. The first-order time derivatives may be obtained by performing a differential operation on the cepstrum coefficient B₁, the cepstrum coefficient B₂, . . . , and the cepstrum coefficient BN. The second-order time derivatives may be obtained by performing a secondary differential operation on the obtained first-order time derivatives. For a specific operation process, refer to related descriptions of step S102 in a subsequent embodiment corresponding to FIG. 3.

As shown in FIG. 2, after a corresponding operation is performed, the computer device 20 may obtain a first-order time derivative set 206 and a second-order time derivative set 207. The first-order time derivative set 206 may include M first-order time derivatives associated with the audio data frame 203. For example, the M first-order time derivatives may specifically include a first-order time derivative C₁, . . . , and a first-order time derivative C_{M}. Similarly, the second-order time derivative set 207 may include M second-order time derivatives associated with the audio data frame 203. For example, the M second-order time derivatives may specifically include a second-order time derivative D₁, . . . , and a second-order time derivative D_{M}.

In addition, to more accurately characterize a stability feature of the raw audio data, the computer device 20 may further obtain a dynamic spectrum feature associated with the target audio data frame. The audio data frame 203 is still used as an example. After obtaining the historical audio data frame set 204, the computer device 20 may obtain N historical cepstrum coefficients corresponding to each historical audio data frame in the historical audio data frame set 204, for example, may obtain N historical cepstrum coefficients corresponding to the audio data frame A₁, including a cepstrum coefficient A₁₁, a cepstrum coefficient A₁₂, . . . , and a cepstrum coefficient A_{1N}; . . . ; and obtain N historical cepstrum coefficients corresponding to the audio data frame A_{K}, including a cepstrum coefficient A_{K1}, a cepstrum coefficient A_{K2}, . . . , and a cepstrum coefficient A_{KN}. In embodiments of this application, obtained K×N historical cepstrum coefficients may be used as a cepstrum coefficient set 208. It can be understood that a process of obtaining N historical cepstrum coefficients corresponding to each historical audio data frame is similar to the foregoing process of obtaining the N target cepstrum coefficients corresponding to the audio data frame 203. Details are not described herein again.

Further, computer device 20 may determine, based on the K×N historical cepstrum coefficients in the cepstrum coefficient set 208, a dynamic spectrum feature 209 associated with the audio data frame 203. For a specific process thereof, refer to related descriptions of step S103 in the subsequent embodiment corresponding to FIG. 3.

Further, after obtaining the audio feature of the audio data frame 203, the computer device 20 may load a pre-trained target mask estimation model (for example, a mask estimation model 210), and then may input the cepstrum coefficient set 205, the first-order time derivative set 206, the second-order time derivative set 207, and the dynamic spectrum feature 209 to the mask estimation model 210. The mask estimation model 210 may perform mask estimation on the input audio feature to obtain a target mask (for example, a mask 211) corresponding to the audio data frame 203.

Then the computer device 20 may apply the obtained mask 211 to the audio data frame 203 to suppress noise data in the audio data frame 203. It can be understood that a function of the mask is equivalent to retaining, to a maximum extent, the speech data of the service object in the raw audio data while eliminating the noise data that causes interference (for example, talking of other people near the service object). In addition, the processes of processing other audio data frames (for example, the audio data frame A₁, . . . , and the audio data frame A_{K}) by the computer device 20 are similar to the processing process for the audio data frame 203. Details are not described herein again.

Finally, after performing noise suppression on each audio data frame in audio data frame set 202, the computer device 20 may obtain enhanced audio data 212 corresponding to the raw audio data 201. In this case, the enhanced audio data 212 includes a very small amount of noise data, and the speech data of the service object is effectively retained. High speech fidelity is achieved.

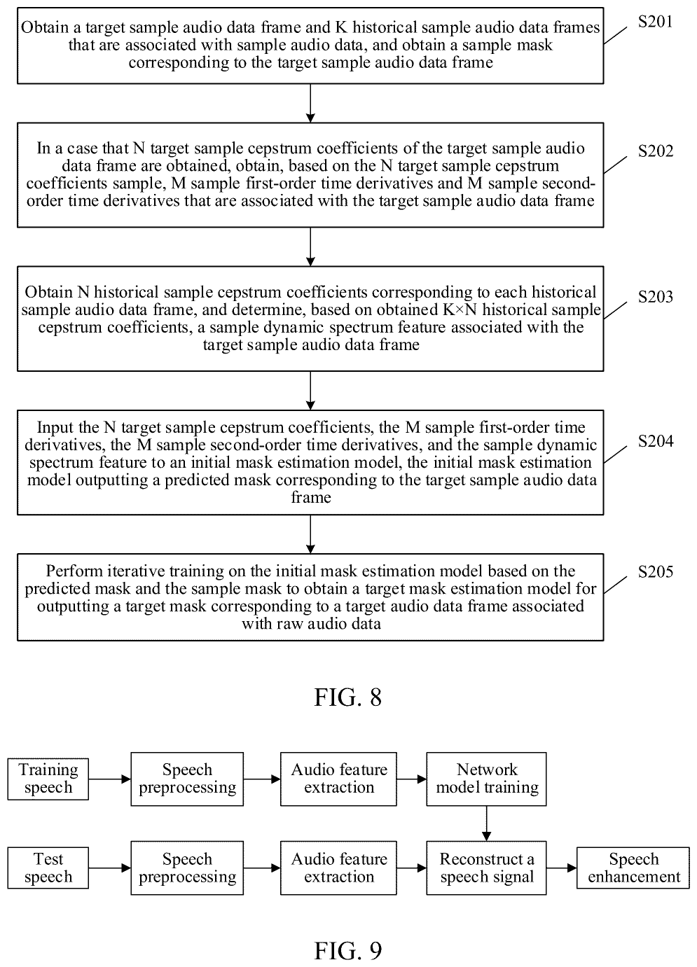

It can be understood that the computer device 20 may train a neural network by using an audio database including massive audio data to obtain the mask estimation model 210. For a specific training process, refer to a subsequent embodiment corresponding to FIG. 8.

It can be understood that a source of the raw audio data may vary in different service scenarios. Correspondingly, the function of enhanced audio data that is finally obtained may also vary. For example, in real-time audio/video communication scenarios such as audio/video conferencing, audio/video calls, audio/video livestreaming, audio/video interviews, or remote visiting, the computer device 20 may transmit enhanced audio data F1 obtained through real-time speech enhancement on raw audio data E1 to a user terminal of another user who performs audio/video communication with a service object 1. For another example, in a speech enhancement scenario for a hearing-aid device, the computer device 20 may perform speech enhancement on raw audio data E2 that is associated with a service object 2 and that is obtained by the hearing-aid device, so that enhanced audio data F2 including clear speech data of the service object 2 can be returned to the hearing-aid device for play. For another example, in a speech recognition scenario, after obtaining raw audio data E3 input by a service object 3, the computer device 20 may first perform speech enhancement on the raw audio data E3 to obtain enhanced audio data F3, and then may perform speech recognition on high-quality speech data included in the enhanced audio data F3, so that accuracy of speech recognition can be improved. For another example, in an audio/video recording scenario, the computer device 20 may perform speech enhancement on raw audio data E4 that is input by a service object 4, and may store or transmit obtained enhanced audio data F4 (for example, the enhanced audio data may be stored in a local cache of the computer device 20 or uploaded to a cloud storage) (for example, the enhanced audio data may be transmitted, as an audio/video session message during instant messaging, to another user terminal for play). For another example, in an audio/video production scenario, the computer device 20 may obtain raw audio data E5 from a to-be-processed multimedia file and perform speech enhancement on the raw audio data, and then may replace the raw audio data E5 in the to-be-processed multimedia file with enhanced audio data F5, to improve audio quality of the multimedia file.

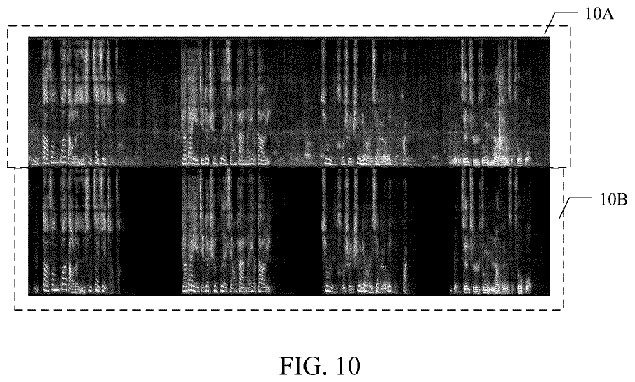

In some embodiments, obtaining, by the computer device 20, a target mask estimation model by training an initial mask estimation model, obtaining a target audio feature of a target audio data frame associated with raw audio data, performing mask estimation on the target audio feature through the target mask estimation model, outputting a target mask corresponding to the target audio data frame, and performing noise suppression by using the target mask, refer to descriptions in the following embodiments corresponding to FIG. 3 and FIG. 10.

FIG. 3 is a schematic flowchart of an audio data processing method according to an embodiment of this application. It can be understood that the method provided in embodiments of this application may be performed by a computer device. The computer device herein includes but is not limited to a user terminal or a service server on which a target mask estimation model is run. In some embodiments of this application, an example in which the computer device is a user terminal is used to describe a specific process of performing audio processing (for example, speech enhancement) on raw audio data on the user terminal. As shown in FIG. 3, the method may include at least the following step S101 to step S104.

Step S101: Obtain a target audio data frame and K historical audio data frames that are associated with raw audio data.

Specifically, the user terminal may obtain raw audio data that includes speech data of a service object and noise data in an environment. The raw audio data may be audio data captured by the user terminal through an audio device in real time, or may be audio data obtained from a to-be-processed multimedia file, or may be audio data transmitted by another associated user terminal. This is not limited herein.

It can be understood that, from the perspective of statistics, speech data has specific stationarity. For example, speech data may show obvious stationarity and regularity in a pronunciation unit that lasts tens of milliseconds to hundreds of milliseconds. Based on this, during speech enhancement on a piece of audio data, speech enhancement may be performed based on a small pronunciation unit (for example, a phoneme, a word, or a byte). Therefore, before performing audio feature extraction on the raw audio data, the user terminal may perform audio preprocessing on the raw audio data to obtain a plurality of spectral frames in frequency domain.

In one embodiment, a short-time segment may be extracted from the raw audio data by using a sliding window. Specifically, the user terminal may perform framing and windowing preprocessing on the raw audio data to obtain H audio data segments, H being a positive integer greater than 1. A specific quantity of audio data segments is not limited to embodiments of this application.

The framing and windowing preprocessing may include a framing operation and a windowing operation. First, the user terminal may perform the framing operation on the raw audio data to obtain H audio signal frames in time domain. The starting and ending of each audio signal frame obtained through framing are interrupted. Consequently, an error with respect to the raw audio data increases with an increase of the quantity of audio signal frames obtained through segmentation. Therefore, in embodiments of this application, the windowing operation may be used to resolve this problem, so that a framed signal becomes continuous, and each frame of signal can show characteristics of a periodic function. To be specific, the user terminal may perform the windowing operation on each of the obtained H audio signal frames to obtain H continuous audio data segments of the signal. In embodiments of this application, during the windowing operation, each audio signal frame is sequentially multiplied with a window function to obtain a corresponding audio data segment. The window function includes but is not limited to a Vorbis window, a Hamming window, a rectangular window, a Hanning window, and the like. In some embodiments, an appropriate window function may be selected according to a requirement. This is not limited to embodiments of this application.

The user terminal may determine, jointly based on a length of the raw audio data and a frame length and a frame shift used in the framing operation, a quantity of audio signal frames to be obtained through division. The frame length is the length of one audio signal frame. The “length” herein may be expressed in a plurality of manners, for example, may be expressed by using time or a quantity of sampling points. In some embodiments, in a case that the length is expressed by using time, the length of one audio signal frame may usually range from 15 ms to 30 ms. In some embodiments, an appropriate frame length may be selected according to a requirement. This is not limited to embodiments of this application. For example, in some embodiments, the frame length may be set to 20 ms. An audio signal with a frame length of 20 ms is an audio signal with a duration of 20 ms.

In some embodiments, the length may alternatively be expressed by using a quantity of sampling points. For example, in some embodiments, assuming that a sampling rate of the raw audio data is 16 kHz, and the frame length is 20 ms, one audio signal frame may include 320 sampling points: 16 kHz×20 ms.

The frame shift is a moving distance during each time of framing. Starting from the starting point of the first audio signal frame, movement is performed by one frame shift, until a starting point of a next audio signal frame is reached. The frame shift herein may also be expressed in two manners. For example, in some embodiments, the frame shift may be expressed by using time, and the frame shift is set to 12 ms. For another example, in some embodiments, the frame shift may be expressed by using a quantity of sampling points. For raw audio data with a sampling rate of 16 kHz, the frame shift may be set to 192 sampling points.

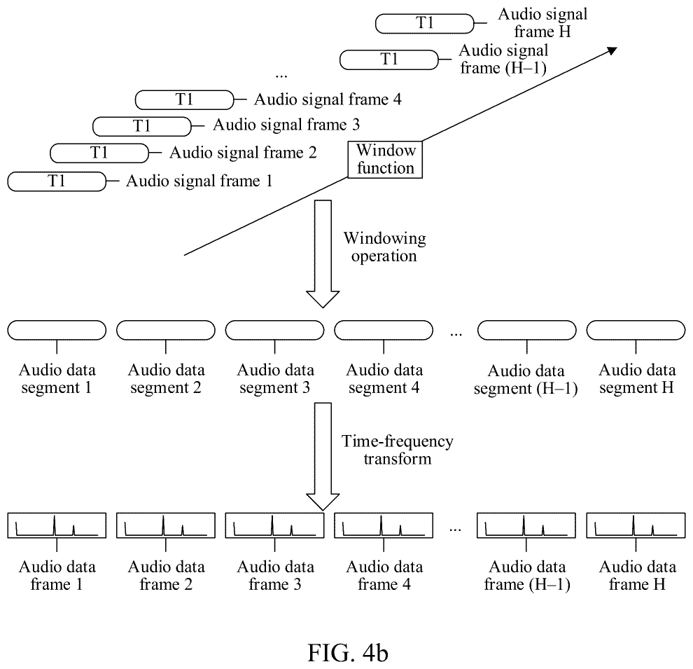

Referring to FIG. 4a and FIG. 4b, FIG. 4a and FIG. 4b are schematic diagrams of a scenario of audio preprocessing according to an embodiment of this application. As shown in FIG. 4a, during a framing operation on raw audio data with a length of T, a frame length may be set to T1 (for example, set to 20 ms), and a frame shift is set to T2 (for example, set to 12 ms). In this case, starting from a starting position of the raw audio data, an audio signal with a frame length of T1 is extracted to obtain the first audio signal frame, namely, an audio signal frame 1. Then movement is performed by one frame shift with a length of T2, and an audio signal with a frame length of T1 is extracted from a position obtained after the movement to obtain the second audio signal frame, namely, an audio signal frame 2. By analogy, H audio signal frames may be finally obtained, where H=(T−T1)/T2+1.

Particularly, during the framing operation, the length of the last remaining signal may be less than one frame. In this case, 0s may be added to the remaining signal to make it reach a length of one frame (namely, T1), or the remaining signal may be directly discarded, because the last frame is at the end of the raw audio data and mainly includes silence clips.

Further, as shown in FIG. 4b, after obtaining the H audio signal frames through the framing operation, the user terminal may apply the window function to each audio signal frame sequentially to obtain a corresponding audio data segment. For example, the audio signal frame 1 may be multiplied by the window function to obtain an audio data segment 1; the audio signal frame 2 may be multiplied by the window function to obtain an audio data segment 2; . . . ; and an audio signal frame H may be multiplied by the window function to obtain an audio data segment H. It can be understood that the audio data segment 1 to the audio data segment H herein are arranged in chronological order.

In some embodiments, an analysis window is a window function used during the framing and windowing preprocessing. However, to achieve perfect reconstruction of a speech signal and reduce a degree of distortion of the speech signal, a synthesis window may be added in a subsequent process of restoring a speech spectrum in frequency domain to a speech signal in time domain. Both the analysis window and the synthesis window may be Vorbis windows. This window function meets the Princen-Bradley criterion. A specific implementation process is not described in embodiments of this application. For a definition of the Vorbis window, see the following formula (1):

$$w ( n ) = sin ( \frac{π}{2} {sin}^{2} ( \frac{π n}{N} ) ) \qquad ( 1 )$$

n is an index of a sampling point to which the Vorbis window is currently applied, N is a window length, and 0≤n≤N−1.

After obtaining the H audio data segments, the user terminal may further perform time-frequency transform on each audio data segment to obtain an audio data frame corresponding to each audio data segment. To be specific, an audio data segment in time domain may be transformed into an audio data frame in frequency domain to obtain a spectral frame on which noise suppression can be performed more easily.

In some embodiments of this application, any one of the H audio data segments is used as an example to describe a specific process of time-frequency transform. Assuming that the H audio data segments include an audio data segment i, i being a positive integer less than or equal to H, the user terminal may first perform time-frequency transform, for example, Fourier transform such as fast Flourier transform (FFT), on the audio data segment i to obtain a direct-current component frequency bin and 2S frequency bins of the audio data segment i in frequency domain. To be specific, a total of (1+2S) frequency bins may be obtained after the Fourier transform, S being a positive integer. The quantity of frequency bins is not limited in embodiments of this application. The quantity of sampling points of an audio signal frame corresponding to each audio data segment may be the same as or different from a quantity of frequency bins corresponding to the audio data segment. In practical application, a quantity of frequency bins obtained after the Fourier transform may be set according to a requirement. For example, in some embodiments, a quantity of sampling points corresponding to each audio signal frame is 320. In this case, during time-frequency transform, a quantity of frequency bins corresponding to each audio data segment may be set to 512.

It can be learned from properties of the Fourier transform that the (1+2S) frequency bins obtained after the Fourier transform are complex numbers. Each complex number corresponds to a frequency. A modulus value of the complex number may represent an amplitude feature of the frequency. The amplitude feature and an amplitude of a corresponding audio signal have a specific proportional relationship. 2S complex numbers other than the first complex number (namely, the direct-current component frequency bin) are conjugate-symmetric with respect to their centers. Modulus values (or amplitudes) of two conjugate-symmetric complex numbers are the same. Therefore, only spectra of half of the 2S frequency bins need to be selected. In some embodiments of this application, the first S frequency bins of the 2S frequency bins may be identified as frequencies related to a first frequency bin type. Correspondingly, the last S frequency bins of the 2S frequency bins may be identified as frequencies related to a second frequency bin type. To be specific, the 2S frequency bins may include S frequency bins related to the first frequency bin type and S frequency bins related to the second frequency bin type. It can be understood that the S frequency bins related to the first frequency bin type and the S frequency bins related to the second frequency bin type are conjugate-symmetric with respect to their centers.

Then the user terminal may obtain the S frequency bins related to the first frequency bin type from the 2S frequency bins, and may determine, based on the S frequency bins related to the first frequency bin type and the direct-current component frequency bin, an audio data frame corresponding to the audio data segment i. Alternatively, in some embodiments, due to characteristics of conjugate symmetry, the user terminal may determine, based on the S frequency bins related to the second frequency bin type and the direct-current component frequency bin, an audio data frame corresponding to the audio data segment i. This is not limited to embodiments of this application.

It can be understood that the audio data frame corresponding to the audio data segment i is a spectral frame in frequency domain. For example, in some embodiments, after the time-frequency transform, 513 frequencies are correspondingly obtained for each audio data segment, including one direct-current component frequency bin and 512 frequencies having a conjugate-symmetric relationship. In this case, the first half of the 512 frequencies (namely, frequencies related to the first frequency bin type) and the direct-current component frequency bin may be used to constitute a corresponding audio data frame.

For example, it is assumed that five frequencies (that is, S=2) are obtained after Fourier transform is performed on the audio data segment i, including one direct-current component frequency bin (a+bi), and a frequency bin (c+di), a frequency bin (e+fi), a frequency bin (c−di), and a frequency bin (e−fi). The frequency bin (c+di) and the frequency bin (c−di) are a pair of conjugate complex numbers. The frequency bin (e+fi) and the frequency bin (e−Fi) are also a pair of conjugate complex numbers. Therefore, the frequency bin (c+di) and the frequency bin (e+fi) may be considered as frequencies related to the first frequency bin type, and the frequency bin (c−di) and the frequency bin (e−fi) may be considered as frequencies related to the second frequency bin type. Further, the audio data frame corresponding to the audio data segment i may be determined based on the direct-current component frequency bin (a+bi), the frequency bin (c+di), and the frequency bin (e+fi); or the audio data frame corresponding to the audio data segment i may be determined based on the direct-current component frequency bin (a+bi), the frequency bin (c−di), and the frequency bin (e−fi).

As shown in FIG. 4b, time-frequency transform may be performed on the audio data segment 1 to obtain an audio data frame 1; time-frequency transform may be performed on the audio data segment 2 to obtain an audio data frame 2; . . . ; and time-frequency transform may be performed on the audio data segment H to obtain an audio data frame H It can be understood that a sequence of the H audio data frames in frequency domain is consistent with that of the H audio data segments in time domain.

It can be understood that, after obtaining the H audio data frames, the user terminal may determine a target audio data frame and K historical audio data frames preceding the target audio data frame. The target audio data frame and the K historical audio data frames are spectral frames. The target audio data frame may be any to-be-processed audio data frame of the H audio data frames, and each of the K historical audio data frames is a spectral frame preceding the target audio data frame, K being a positive integer less than H. The value of K is not limited in embodiments of this application. Still as shown in FIG. 4b, assuming that an audio data frame 4 is used as the target audio data frame, spectral frames preceding the audio data frame 4 are the audio data frame 1, the audio data frame 2, and an audio data frame 3. For example, in the case of K=2, the audio data frame 2 and the audio data frame 3 that are closest to the audio data frame 4 may be used as required historical audio data frames.

During processing on each audio data frame, K historical audio data frames preceding the audio data frame need to be obtained. Particularly, in a case that a quantity of historical audio data frames preceding a current audio data frame does not meet the specified quantity of K, 0s may be added to make the quantity of historical audio data frames preceding the audio data frame reach K. For example, with reference to FIG. 4b, assuming that the audio data frame 1 is used as the target audio data frame and K=2, it can be learned that no spectral frame precedes the audio data frame 1 after the time-frequency transform. Therefore, two all-0 spectral frames may be added in front of the audio data frame 1 as historical audio data frames preceding the audio data frame 1.

Step S102: In a case that N target cepstrum coefficients of the target audio data frame are obtained, obtain, based on the N target cepstrum coefficients, M first-order time derivatives and M second-order time derivatives that are associated with the target audio data frame.

It can be understood that the user terminal performs audio features extraction on the target audio data frame after obtaining the target audio data frame through audio preprocessing. Specifically, N cepstrum coefficients that can characterize an acoustic feature of the target audio data frame may be obtained. The N cepstrum coefficients may be collectively referred to as target cepstrum coefficients. In addition, M first-order time derivatives, M second-order time derivatives, and a dynamic spectrum feature that can characterize a feature of temporal correlation between different speech signals may be further obtained. N is a positive integer greater than 1, and M is a positive integer less than N. A process of obtaining the target cepstrum coefficients, the first-order time derivatives, and the second-order time derivatives that are associated with the target audio data frame is described below in detail.

A specific process of obtaining the N target cepstrum coefficients of the target audio data frame includes It is assumed that the target audio data frame includes a total of S1 frequency bins, the S1 frequency bins include a direct-current component frequency bin and S2 frequency bins related to a frequency bin type, S1 and S2 are positive integers, and S1=1+S2. With reference to the descriptions of the time-frequency transform process in step S101, the S2 frequency bins related to a frequency bin type may be S frequency bins related to the first frequency bin type or S frequency bins related to the second frequency bin type, where S2=S. Based on this, the user terminal may map the S1 (for example, 256+1) frequency bins to N (for example, 56) acoustic bands, S1 being greater than or equal to N. To be specific, frequencies of the S1 frequency bins may be divided according to a coarser frequency scale (namely, the acoustic band in embodiments of this application), to reduce complexity of subsequent calculation.

Further, cepstrum processing may be performed on each acoustic band to obtain a target cepstrum coefficient corresponding to each acoustic band. It is assumed herein that N acoustic bands include an acoustic band j, j being a positive integer less than or equal to N. A specific process of performing cepstrum processing on the acoustic band j may be as follows:

First, the band energy of the acoustic band j may be obtained.

In some embodiments, triangular filtering may be performed on frequency bin data to obtain band energy corresponding to the frequency bin data in each acoustic band. For example, a triangular filter (for example, a triangular filter j) associated with the acoustic band j may be obtained from a triangular filter bank including N triangular filters, and then each filter point in the triangular filter j may be applied to a frequency bin at a corresponding position in the acoustic band j to obtain band energy of the acoustic band j.

In some embodiments, in a case that a quantity of acoustic bands is 56, 56 triangular filters are also needed correspondingly.

Further, logarithmic transform may be performed on the band energy of the acoustic band j to obtain logarithmic band energy of the acoustic band j. Then discrete cosine transform (DCT) may be performed on the logarithmic band energy of the acoustic band j to obtain a target cepstrum coefficient corresponding to the acoustic band j.

It can be understood that the N target cepstrum coefficients of the target audio data frame may be obtained after cepstrum processing is performed on each acoustic band. A process of obtaining cepstrum coefficients of another audio data frame is consistent with that of obtaining the target cepstrum coefficients. Details are not described herein again.

In the related art, a size of a frequency bin (which may be understood as a spacing between samples in frequency domain) is directly estimated by using a neural network. This leads to very high calculation complexity. To resolve this problem, no sample or spectrum is directly processed in this application. Assuming that spectral envelopes of speech and noise are sufficiently flat, a resolution coarser than the frequency bin may be used. To be specific, frequencies of each frequency bin are divided into coarser frequency scales to reduce calculation complexity. These coarser frequency scales may be referred to as acoustic bands in embodiments of this application. Different acoustic bands may be used for characterizing nonlinear features of human ears' perception of sound.

The acoustic band in embodiments of this application may be a Bark frequency scale, a Mel frequency scale, or another frequency scale. This is not limited herein. For example, the Bark frequency scale is used as an example. The Bark frequency scale is a frequency scale that matches human ears' perception of sound. The Bark frequency scale is based on Hz. It maps frequencies to 24 critical bands of psychoacoustics. The 25^{th} critical band occupies frequencies of approximately 16 kHz to 20 kHz. The width of one critical band is equal to one Bark. In short, the Bark frequency scale converts a physical frequency into a psychoacoustic frequency.

With reference to the foregoing steps, in a case that frequency bins are directly used, spectrum values (complex numbers) of S1 (for example, 257) frequency bins need to be considered. In this case, a large amount of data is subsequently input to the target mask estimation model. Therefore, in embodiments of this application, the S1 frequency bins are re-divided into N acoustic bands (bands) based on characteristics of band envelopes, to reduce the amount of calculation.

For example, in some embodiments, a Bark domain may be approximately expressed by using various approximation functions. It is assumed that a sampling rate is 16 kHz, a window length is 512, a frame length is 20 ms, a frame shift is 12 ms, and an audio data frame obtained after Fourier transform includes 257 frequency bins. In this case, the 257 frequency bins may be divided into 56 acoustic bands based on a specified band approximation function. Division is performed based on the following code:

$$static const opus\_int16 eband 5 ms [ ] = \{ // eband 20 ms - 56 ok$$

0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 34, 36, 38, 40, 42, 44, 46, 48, 56, 64, 72, 80, 92, 104, 116, 128, 144, 160, 176, 192, 208, 232, 256

To be specific, a frequency bin 0 (namely, the first frequency bin, which is a direct-current component frequency bin) may be divided into the first acoustic band, a frequency bin 1 (namely, the second frequency bin) may be divided into the second acoustic band, . . . , a frequency bin 232 to a frequency bin 255 are divided into the 55^{th} acoustic band, and a frequency bin 256 is divided into the 56^{th} acoustic band. Then cepstrum processing may be separately performed on the 56 acoustic bands (to be specific, band energy of each acoustic band undergoes logarithmic transform and then DCT). Finally, 56 Bark frequency cepstrum coefficients (BFCCs) are obtained.

In addition to the N target cepstrum coefficients, first-order time derivatives and second-order time derivatives of the N target cepstrum coefficients are further considered. A specific process of obtaining, by the user terminal based on the N target cepstrum coefficients, the M first-order time derivatives and the M second-order time derivatives that are associated with the target audio data frame may be as follows:

First, a differential operation is performed on the N target cepstrum coefficients to obtain (N−1) differential operation values. Then each of the (N−1) differential operation values may be used as a first-order time derivative, and the M first-order time derivatives associated with the target audio data frame may be obtained from the (N−1) first-order time derivatives. Similarly, a secondary differential operation may be performed on the (N−1) first-order time derivatives to obtain (N−2) differential operation values. Then each of the (N−2) differential operation values may be used as a second-order time derivative, and the M second-order time derivatives associated with target audio data frame may be obtained from the (N−2) second-order time derivatives. The value of M is not limited in embodiments of this application. For example, in some embodiments, M may be set to 6.

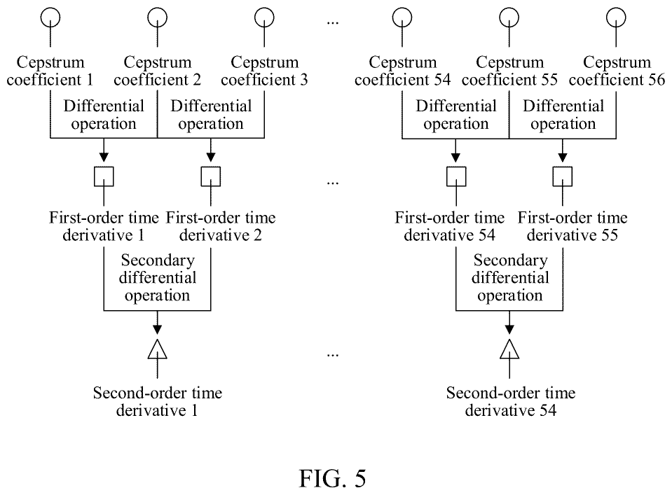

Referring to FIG. 5, FIG. 5 is a schematic diagram of a scenario of a differential operation on cepstrum coefficients according to an embodiment of this application. As shown in FIG. 5, it is assumed that an audio data frame corresponds to 56 cepstrum coefficients (for example, BFCCs): a cepstrum coefficient 1, a cepstrum coefficient 2, a cepstrum coefficient 3, . . . , a cepstrum coefficient 54, a cepstrum coefficient 55, and a cepstrum coefficient 56. A differential operation may be performed on the cepstrum coefficient 1 and the cepstrum coefficient 2 (for example, the cepstrum coefficient 2−the cepstrum coefficient 1) to obtain a first-order time derivative 1; a differential operation may be performed on the cepstrum coefficient 2 and the cepstrum coefficient 3 to obtain a first-order time derivative 2; . . . ; a differential operation may be performed on the cepstrum coefficient 54 and the cepstrum coefficient 55 to obtain a first-order time derivative 54; and a differential operation may be performed on the cepstrum coefficient 55 and the cepstrum coefficient 56 to obtain a first-order time derivative 55.

Then a secondary differential operation may be performed on the obtained first-order time derivative 1 to first-order time derivative 55. For example, a secondary differential operation may be performed on the first-order time derivative 1 and the first-order time derivative 2 (for example, the first-order time derivative 2−the first-order time derivative 1) to obtain a second-order time derivative 1; . . . ; and a secondary differential operation may be performed on the first-order time derivative 54 and the first-order time derivative 55 to obtain a second-order time derivative 54.

In some embodiments, M may be set to 6, and the first 6 first-order time derivatives and the first 6 second-order time derivatives are used. To be specific, a first-order time derivative 1 to a first-order time derivative 6, and a second-order time derivative 1 to a second-order time derivative 6 are used.

Step S103: Obtain N historical cepstrum coefficients corresponding to each historical audio data frame, and determine, based on obtained K×N historical cepstrum coefficients, a dynamic spectrum feature associated with the target audio data frame.

In addition to the target cepstrum coefficients, the first-order time derivatives, and the second-order time derivatives mentioned in step S102, a stationarity measure of a previous audio data frame on a current audio data frame, namely, a dynamic spectrum feature, may be further considered. The feature may be obtained based on band difference values corresponding to K historical audio data frames in the past.

In some embodiments, N historical cepstrum coefficients corresponding to each historical audio data frame may be obtained during processing on the historical audio data frame (to be specific, in a case that the audio data frame is used as a target audio data frame, for a specific process, refer to the process of obtaining the N target cepstrum coefficients in step S102). Therefore, the user terminal may store, by using its cache (for example, a ring buffer structure), N historical cepstrum coefficients corresponding to the latest K historical audio data frames preceding a current target audio data frame. When each target audio data frame is updated to the next audio data frame, historical cepstrum coefficients in the cache are correspondingly updated.

Specifically, any two adjacent historical audio data frames may be obtained from the K historical audio data frames preceding the target audio data frame as a first historical audio data frame and a second historical audio data frame, the second historical audio data frame being a spectral frame obtained after the first historical audio data frame. Then N historical cepstrum coefficients corresponding to the first historical audio data frame and N historical cepstrum coefficients corresponding to the second historical audio data frame may be obtained from a cache related to the target audio data frame (for example, a local cache of the user terminal).

The determining, based on obtained K×N historical cepstrum coefficients, a dynamic spectrum feature associated with the target audio data frame specifically includes: using N coefficient difference values between the N historical cepstrum coefficients corresponding to the first historical audio data frame and the N historical cepstrum coefficients corresponding to the second historical audio data frame as interframe difference values between the first historical audio data frame and the second historical audio data frame; and determining the dynamic spectrum feature associated with the target audio data frame based on K−1 interframe difference values between adjacent historical audio data frames in the K historical audio data frames.

In some embodiments of this application, the obtained N historical cepstrum coefficients corresponding to the first historical audio data frame may be used as first historical cepstrum coefficients, and the obtained N historical cepstrum coefficients corresponding to the second historical audio data frame may be used as second historical cepstrum coefficients.

Further, band difference values between the first historical cepstrum coefficients and the second historical cepstrum coefficients may be used as interframe difference values between the first historical audio data frame and the second historical audio data frame. A specific process may be as follows: A historical cepstrum coefficient Lₚ is obtained from the N historical cepstrum coefficients included in the first historical cepstrum coefficients, and a historical cepstrum coefficient L_{q} may be obtained from the N historical cepstrum coefficients included in the second historical cepstrum coefficients, p and q being positive integers, p=1, . . . , N, q=1, . . . , N, and p=q. Further, a coefficient difference value between the historical cepstrum coefficient Lₚ and the historical cepstrum coefficient L_{q} (for example, the historical cepstrum coefficient Lₚ—the historical cepstrum coefficient L_{q}) may be obtained. Then N coefficient difference values may be determined as the band difference values between the first historical cepstrum coefficients and the second historical cepstrum coefficients. That is, the band difference values include the N coefficient difference values. Then the band difference values may be used as interframe difference values between the first historical audio data frame and the second historical audio data frame.

In some embodiments, a difference value sum of N coefficient difference values included in all interframe difference values may be obtained, and then the difference value sum may be averaged (for example, the difference value sum/K) to obtain a corresponding dynamic spectrum feature.

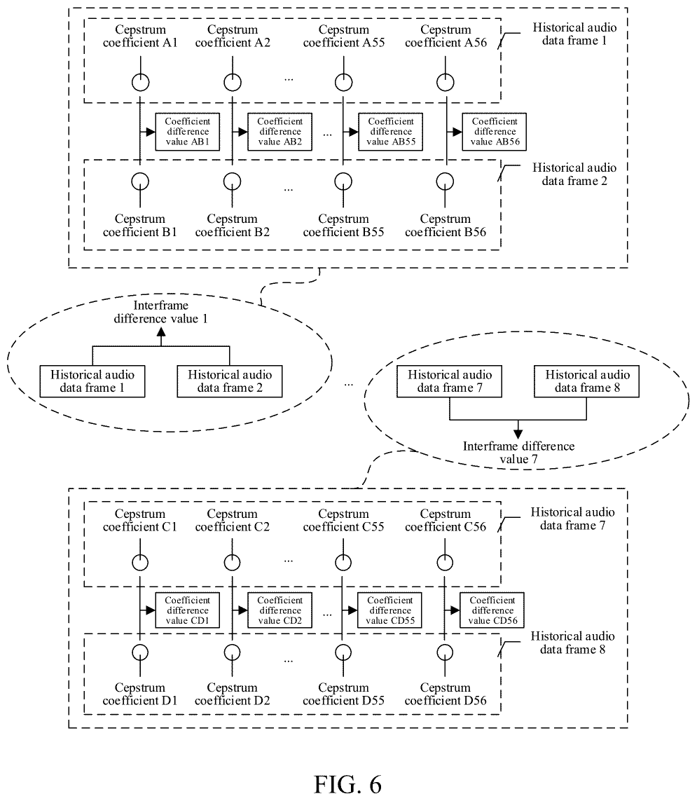

Referring to FIG. 6, FIG. 6 is a schematic diagram of a scenario of obtaining an interframe difference value according to an embodiment of this application. As shown in FIG. 6, it is assumed that eight historical audio data frames (that is, K=8) currently exist, which are sequentially a historical audio data frame 1, a historical audio data frame 2, . . . , a historical audio data frame 7, and a historical audio data frame 8. Each historical audio data frame corresponds to 56 historical cepstrum coefficients (that is, N=56). For example, the historical audio data frame 1 corresponds to a cepstrum coefficient A1 to a cepstrum coefficient A56, the historical audio data frame 2 corresponds to a cepstrum coefficients B1 to a cepstrum coefficients B56, . . . , the historical audio data frame 7 corresponds to a cepstrum coefficient C1 to a cepstrum coefficient C56, and the historical audio data frame 8 corresponds to a cepstrum coefficient D1 to a cepstrum coefficient D56.

In a case that the historical audio data frame 1 is the first historical audio data frame and the historical audio data frame 2 is the second historical audio data frame, the first historical cepstrum coefficients include the cepstrum coefficient A1 to the cepstrum coefficient A56, and the second historical cepstrum coefficients include the cepstrum coefficient B1 to the cepstrum coefficient B56. In this case, a coefficient difference value AB1 between the cepstrum coefficient A2 and the cepstrum coefficient B1 (for example, the cepstrum coefficient A2−the cepstrum coefficient B1) may be obtained, a coefficient difference value AB2 between the cepstrum coefficient A2 and the cepstrum coefficient B2 may be obtained, . . . , a coefficient difference value AB55 between the cepstrum coefficient A55 and the cepstrum coefficient B55 may be obtained, and a coefficient difference value AB56 between the cepstrum coefficient A56 and the cepstrum coefficient B56 may be obtained. Then 56 coefficient difference values (namely, the coefficient difference value AB1 to the coefficient difference value AB56) may be used as an interframe difference value 1 between the historical audio data frame 1 and the historical audio data frame 2.

By analogy, in a case that the historical audio data frame 7 is the first historical audio data frame and the historical audio data frame 8 is the second historical audio data frame, likewise, 56 coefficient difference values (namely, a coefficient difference value CD1 to a coefficient difference value CD56) may be obtained as an interframe difference value 7 between the historical audio data frame 7 and the historical audio data frame 8.

Then a dynamic spectrum feature associated with a current audio data frame may be determined based on interframe difference values (namely, the interframe difference value 1 to the interframe difference value 7) between the eight historical audio data frames. For example, all 56 coefficient difference values included in each interframe difference value may be added to obtain a corresponding difference value sum, and then the eight difference value sums may be averaged to obtain a corresponding dynamic spectrum feature. To be specific, the dynamic spectrum feature=(the coefficient difference value AB1+ . . . +the coefficient difference value AB56+ . . . +the coefficient difference value CD1+ . . . +the coefficient difference value CD56)/8.

In a case that a quantity of historical audio data frames preceding a current audio data frame does not meet the specified quantity of K (for example, eight), 0s may be added to obtain K historical audio data frames in embodiments of this application. A historical audio data frame obtained by adding 0s is an all-0 spectral frame. Correspondingly, N cepstrum coefficients corresponding to the all-0 spectral frame may also be set to 0.

Step S104: Input the N target cepstrum coefficients, the M first-order time derivatives, the M second-order time derivatives, and the dynamic spectrum feature to a target mask estimation model, the target mask estimation model outputting a target mask corresponding to the target audio data frame.

It can be understood that, in an ML/DL-based intelligent speech enhancement technology inspired by the concept of time frequency (T-F) masking in computational auditory scene analysis (CASA), selection of a training object is quite important for both learning and generalization in supervised speech enhancement.

The training object is defined in a T-F representation of a speech signal, for example, is a spectrum graph calculated based on short-time Fourier transform. Training objects are mainly classified into two categories: masking-based objects, for example, an ideal ratio mask (IRM) that describes a time-frequency relationship between pure speech and babble noise; and mapping-based objects, for example, a logarithmic power spectrum that corresponds to a spectral representation of clean speech.

In embodiments of this application, the former manner is used: A mask is estimated from an input feature based on a nonlinear fitting capability of a neural network. Then the mask is multiplied by a spectrum of a noisy speech signal (namely, the raw audio data in embodiments of this application), and then a time domain waveform is reconstructed for the purpose of enhancement.

Specifically, the user terminal may use a total of (N+2M+1) features, including the N target cepstrum coefficients, the M first-order time derivatives, the M second-order time derivatives, and the dynamic spectrum feature that are obtained in the foregoing steps, as a target audio feature of the target audio data frame, and may input the target audio feature to the target mask estimation model for mask estimation. For example, in some embodiments, a quantity of target cepstrum coefficients is 56, and a quantity of first-order time derivatives and a quantity of second-order time derivatives each are 6. In this case, the size of the target audio feature input to target mask estimation model is as follows: 56+6×2+1=69.

The neural network-based target mask estimation model has a very strong nonlinear fitting capability. Therefore, an initial mask estimation model may be trained to learn how to obtain a mask from a noisy audio feature through calculation. For a specific process of model training, refer to an embodiment corresponding to FIG. 8.

In one embodiment, the target mask estimation model may include a mask estimation network layer and a mask output layer. In this case, the obtained target audio feature may be first input to the mask estimation network layer, and the mask estimation network layer may perform mask estimation on the input target audio feature to obtain a hidden feature corresponding to the target audio feature. Further, the hidden feature may be input to the mask output layer. The mask output layer performs feature combination on the hidden feature to obtain a target mask corresponding to the target audio data frame. The length of the target mask is N (the same as a quantity of acoustic bands obtained through division). In embodiments of this application, the target mask may be used for suppressing noise data in the raw audio data to obtain enhanced audio data corresponding to the raw audio data.

In embodiments of this application, the mask may also be referred to as a gain or a band gain, and may include but is not limited to an IRM, an ideal binary mask (IBM), an optimal ratio mask (ORM), and the like. The type of the target mask is not limited herein.

Based on an assumption that target speech and babble noise are orthogonal, to be specific, target speech and babble noise are uncorrelated, the IRM directly describes a ratio of pure speech energy to noisy speech energy in a time-frequency unit. The value of the IRM ranges from 0 to 1. A larger value indicates a higher proportion of the target speech in the time-frequency unit.

The target speech is sparsely distributed in time/frequency domain. For a specific time-frequency unit, the difference between energy of the target speech and energy of the babble noise is usually large. Therefore, the signal-to-noise ratio in most time-frequency units is excessively high or excessively low. IBM is a simplified description of this case, and discretizes a continuous signal-to-noise ratio of a time-frequency unit into two states: 1 and 0. In a time-frequency unit, target speech being dominant (a signal-to-noise ratio is high) is marked as 1, and babble noise being dominant (a signal-to-noise ratio is low) is marked as 0. Finally, the IBM is multiplied by noisy speech. This means resetting a time-frequency unit with a low signal-to-noise ratio to eliminate babble noise. Therefore, IBM may be considered as a binary version of the IRM. A definition of the ORM is derived by minimizing a mean square error of pure speech and estimated target speech, and is quite similar to that of the IRM.

In some embodiments, the mask estimation network layer may include a first mask estimation network layer, a second mask estimation network layer, and a third mask estimation network layer that have a skip connection. The skip connection between the first mask estimation network layer, the second mask estimation network layer, and the third mask estimation network layer can avoid network overfitting.

A specific process of performing, by the mask estimation network layer, mask estimation on the input target audio feature may be as follows:

The target audio feature is input to the first mask estimation network layer, and the first mask estimation network layer outputs a first intermediate feature.

Then feature splicing may be performed on the first intermediate feature and the target audio feature based on a skip connection between the first mask estimation network layer and the second mask estimation network layer to obtain a second intermediate feature. Then the obtained second intermediate feature may be input to the second mask estimation network layer, and the second mask estimation network layer may output a third intermediate feature.

Further, feature splicing may be performed on the third intermediate feature, the target audio feature, and the first intermediate feature based on a skip connection between the first mask estimation network layer and the third mask estimation network layer, and a skip connection between the second mask estimation network layer and the third mask estimation network layer, to obtain a fourth intermediate feature.

The fourth intermediate feature is input to the third mask estimation network layer, and the third mask estimation network layer outputs the hidden feature corresponding to the target audio feature.

In some embodiments, the target mask estimation model may alternatively include more or fewer mask estimation network layers. A specific quantity of mask estimation network layers is not limited to embodiments of this application.

Network structures of the first mask estimation network layer, the second mask estimation network layer, and the third mask estimation network layer in the mask estimation network layer may be gated recurrent units (GRUs) or long short-term memory networks (LSTMs). A network structure of the mask output layer may be the fully connected layer or the like. Specific structures of the mask estimation network layer and the mask output layer are not limited in embodiments of this application.

The GRU is a gating mechanism in a recurrent neural network. Similar to the LSTM with a forget gate, the GRU includes an update gate and a reset gate. Compared with the LSTM, the GRU does not include an output gate, and has fewer parameters than the LSTM. Therefore, in a case that the GRU is used for designing the mask estimation network layer, a lightweight mask estimation model may be obtained.

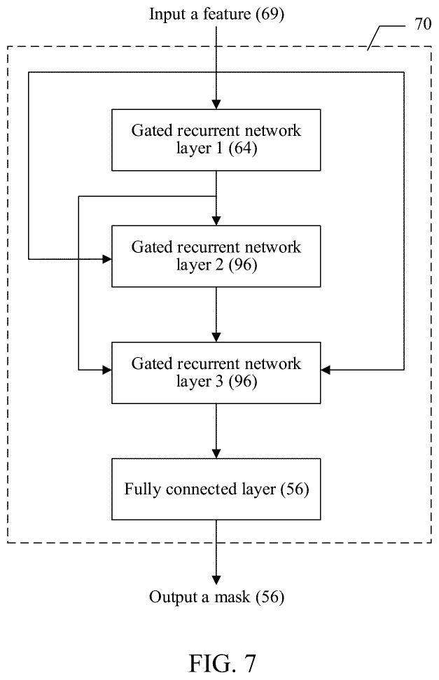

Referring to FIG. 7, FIG. 7 is a schematic diagram of a network structure of a mask estimation model according to an embodiment of this application. As shown in FIG. 7, after a corresponding audio feature (for example, an audio feature with a size of 69) is obtained, the audio feature may be input to a mask estimation model 70 (namely, the target mask estimation model). The model may include a gated recurrent network layer 1 (namely, the first mask estimation network layer), a gated recurrent network layer 2 (namely, the second mask estimation network layer), a gated recurrent network layer 3 (namely, the third mask estimation network layer), and a fully connected layer (namely, the mask output layer). A three-layer simple GRU neural network is used for modeling the audio feature. The last layer, namely, the fully connected layer, is used for outputting a gain (namely, a mask).

In this embodiment, the quantity of features corresponding to each audio data frame input to the model may be 69. The three gated recurrent network layers that the audio data frame passes may include 64, 96, and 96 nodes (also referred to as neurons or perceptrons) respectively. Correspondingly, feature dimensionality of a first intermediate feature outputted by the gated recurrent network layer 1 is 64, feature dimensionality of a third intermediate feature outputted by the gated recurrent network layer 2 is 96, and feature dimensionality of a hidden feature outputted by the gated recurrent network layer 3 is 96. In addition, the fully connected layer may include 56 nodes. In this case, the dimensionality of a finally outputted mask is 56 (to be specific, 56 mask values are outputted).

An appropriate activation function may be used for each network layer. For example, a rectified linear unit (ReLu) function may be used for the gated recurrent network layer 1, a ReLu function may be used for the gated recurrent network layer 2, and a hyperbolic tangent (tan h) function may be used for the gated recurrent network layer 3. In a case that the IRM is used for the mask, a sigmoid function may be used for the fully connected layer to ensure that a value range of the output mask is (0, 1). Another function may alternatively be used as an activation function for each of the foregoing network layers. This is not limited to embodiments of this application.

The target mask estimation model used in embodiments of this application is a lightweight neural network. The three mask estimation network layers in the model can achieve good mask estimation effect, and include a few network parameters, so that network complexity is low. This can reduce calculation time and CPU consumption.

It can be understood that the energy of noisy speech is certainly greater than that of pure speech under an assumption that noise and speech are uncorrelated. N acoustic bands are obtained through division in frequency domain for calculating energy. For each acoustic band, the band including less noise indicates that speech is pure and a band gain is larger. Based on this, for noisy speech, each acoustic band is multiplied by a gain. A physical meaning lies in that the acoustic band may be multiplied by a small gain in a case that noise in the acoustic band is large, and the acoustic band may be multiplied by a large gain in a case that noise in the acoustic band is small. Accordingly, speech can be enhanced, and noise can be suppressed.

In embodiments of this application, after obtaining the target mask (namely, a band gain) through the foregoing steps, the user terminal may perform noise suppression by using the target mask. A specific process may be as follows:

In a case that a length (namely, N) of the target mask is less than a length (namely, S1) of the target audio data frame, interpolation needs to be performed on the target mask to obtain a corresponding interpolation mask. In this case, the length of the obtained interpolation mask is the same as the length (for example, 257 frequency bins) of the target audio data frame.

Further, the interpolation mask may be multiplied by the target audio data frame. To be specific, each mask value in the interpolation mask is correspondingly applied to each frequency bin obtained through Fourier transform in the target audio data frame. Then inverse Fourier transform may be performed on a multiplication result to obtain target audio data that is obtained after noise suppression is performed on the target audio data frame. That is, an enhanced time domain speech signal is obtained through restoration.

It can be understood that a process of performing noise suppression on other audio data is similar to the process of performing noise suppression on the target audio data frame. Details are not described herein again.

Finally, after noise suppression is performed on each audio data frame associated with the raw audio data, enhanced audio data corresponding to the raw audio data may be obtained based on target audio data corresponding to each audio data frame. In this case, the obtained enhanced audio data includes small noise, and speech data of a service object is not mistakenly eliminated. Therefore, the enhanced audio data has very high speech fidelity.

It can be learned from the foregoing descriptions that, in embodiments of this application, a plurality of audio features, including the target cepstrum coefficients, the first-order time derivatives, the second-order time derivatives, and the dynamic spectrum feature, may be comprehensively considered during speech enhancement on the raw audio data. Accordingly, a time-frequency relationship between the speech data of the service object and babble noise data can be more accurately described. To be specific, a more accurate target mask can be obtained. Wanted speech is not suppressed during suppression of the babble noise. Therefore, each output mask is applied to a corresponding audio data frame. This can effectively suppress noise data in audio data and improve speech fidelity. Especially, in a real-time audio/video communication scenario (for example, a real-time audio/video conferencing scenario), high-quality and high-definition speech can be provided for a user to improve user experience.

In addition, in embodiments of this application, a corresponding audio feature is extracted from noisy audio data by using the DSP technology, and then the extracted audio feature is input to a lightweight neural network model (namely, the target mask estimation model) for rapid mask estimation. Therefore, lower network complexity is required in embodiments of this application, so that calculation complexity and central processing unit (CPU) consumption can be reduced, and efficiency of audio data processing is improved.

FIG. 8 is a schematic flowchart of an audio data processing method according to an embodiment of this application. It can be understood that the method provided in embodiments of this application may be performed by a computer device. The computer device herein includes but is not limited to a user terminal or a service server, for example, the user terminals 200a, the user terminals 200b, the user terminals 200c, . . . , the user terminal 200n, or the service server 100 shown in FIG. 1. In some embodiments of this application, an example in which the computer device is a user terminal is used to describe a specific process of performing, by the user terminal, model training on an initial mask estimation model. As shown in FIG. 8, the method may include at least the following step S201 to step S205.

Step S201: Obtain a target sample audio data frame and K historical sample audio data frames that are associated with sample audio data, and obtain a sample mask corresponding to the target sample audio data frame.

The user terminal may obtain the sample audio data from an audio database including massive audio data. The sample audio data herein may be a noisy speech signal (for example, audio data carrying babble noise and speech data of a sample object).

Then framing and windowing preprocessing, time-frequency transform, or other operations may be performed on the sample audio data to obtain the target sample audio data frame and the K historical sample audio data frames that are associated with the sample audio data. The target sample audio data frame and the K historical sample audio data frames are spectral frames, each of the K historical sample audio data frames is a spectral frame preceding the target sample audio data frame, and K is a positive integer. For a specific process, refer to step S101 in the embodiment corresponding to FIG. 3. Details are not described herein again.

In addition, for subsequent calculation of a loss function, the user terminal may further obtain the sample mask corresponding to the target sample audio data frame.

Step S202: In a case that N target sample cepstrum coefficients of the target sample audio data frame are obtained, obtain, based on the N target sample cepstrum coefficients sample, M sample first-order time derivatives and M sample second-order time derivatives that are associated with the target sample audio data frame,

The user terminal may map a plurality of frequency bins included in the target sample audio data frame to N sample acoustic bands that are obtained through division, and perform cepstrum processing on each sample acoustic band to obtain a target sample cepstrum coefficient corresponding to each sample acoustic band.

Then the M sample first-order time derivatives and the M sample second-order time derivatives that are associated with the target sample audio data frame may be obtained based on the obtained N target sample cepstrum coefficients, N being a positive integer greater than 1, and M being a positive integer less than N. For a specific implementation of this step, refer to step S102 in the embodiment corresponding to FIG. 3. Details are not described herein again.

Step S203: Obtain N historical sample cepstrum coefficients corresponding to each historical sample audio data frame, and determine, based on obtained K×N historical sample cepstrum coefficients, a sample dynamic spectrum feature associated with the target sample audio data frame.

The user terminal may obtain N historical sample cepstrum coefficients corresponding to any two adjacent historical sample audio data frames in the K historical sample audio data frames; then may determine a sample interframe difference value between the two adjacent historical sample audio data frames based on two groups of historical sample cepstrum coefficients that are obtained; and finally may determine, based on K−1 sample interframe difference values, a sample dynamic spectrum feature associated with the target sample audio data frame. For a specific implementation of this step, refer to step S103 in the embodiment corresponding to FIG. 3. Details are not described herein again.

Step S204: Input the N target sample cepstrum coefficients, the M sample first-order time derivatives, the M sample second-order time derivatives, and the sample dynamic spectrum feature to an initial mask estimation model, the initial mask estimation model outputting a predicted mask corresponding to the target sample audio data frame.

The user terminal may use the obtained N target sample cepstrum coefficients, M sample first-order time derivatives, M sample second-order time derivatives, and sample dynamic spectrum feature as a sample audio feature of the target sample audio data frame, and then may input the sample audio feature to the initial mask estimation model. The initial mask estimation model outputs the predicted mask corresponding to the target sample audio data frame.

For an exemplary network structure of the initial mask estimation model, refer to the embodiment corresponding to FIG. 7. For a specific implementation of this step, refer to step S104 in the embodiment corresponding to FIG. 3. Details are not described herein again.

Step S205: Perform iterative training on the initial mask estimation model based on the predicted mask and the sample mask to obtain a target mask estimation model, the target mask estimation model being used for outputting a target mask corresponding to a target audio data frame associated with raw audio data.

The user terminal may generate a loss function based on the predicted mask and the sample mask, and then may modify model parameters in the initial mask estimation model based on the loss function. Through a plurality of times of iterative training, the target mask estimation model for outputting the target mask corresponding to the target audio data frame associated with the raw audio data may be finally obtained. The target mask is used for suppressing noise data in the raw audio data to obtain enhanced audio data corresponding to the raw audio data.

In one embodiment, the loss function used for model training may be Huber loss (a parameterized loss function used for regression problems). A formula of the loss function is described as follows:

$$loss = \{ \begin{matrix}0.5 * ( {g}_{true} - {g}_{pred} ) & if \vert {g}_{true} - {g}_{p r e d} \vert \leq d \\ 0.5 * {( {g}_{true} - {g}_{p r e d} )}^{2} + d * ( \vert {g}_{true} - {g}_{pred} \vert - d ) & if \vert {g}_{true} - {g}_{p r e d} \vert > d\end{matrix} \qquad ( 2 )$$

gₜᵣᵤₑ indicates the sample mask. g_{pred} indicates the predicted mask, and a hyperparameter d in loss may be set to 0.1.

In addition, a loss function in another form may alternatively be used. This is not limited to embodiments of this application.

Referring to FIG. 9, FIG. 9 is a schematic flowchart of model training according to an embodiment of this application. As shown in FIG. 9, a neural network model may be designed to model an extracted audio feature to obtain a corresponding mask, to suppress babble noise in audio data.

Specifically, after training speech 901 (namely, sample audio data) is obtained, speech preprocessing 902 (namely, audio preprocessing) may be performed on the training speech to obtain a plurality of associated sample audio data frames. Then audio feature extraction 903 may be performed on each sample audio data frame sequentially to obtain a sample audio feature corresponding to each sample audio data frame. Then these sample audio features may be separately input to an initial mask estimation model to perform network model training 904, to obtain an intermediate mask estimation model.

In this case, generalization performance of the obtained intermediate mask estimation model further needs to be verified. Similarly, speech preprocessing 906 may be performed on obtained test speech 905 (also referred to as test audio data, which may be obtained together with the sample audio data), to obtain a plurality of test audio data frames. Then audio feature extraction 907 may be performed on each test audio data frame sequentially to obtain a test audio feature corresponding to each test audio data frame.

Further, these test audio features may be separately input to the intermediate mask estimation model, and the intermediate mask estimation model outputs a corresponding mask. In addition, the obtained mask may be applied to a corresponding test audio data frame to obtain a spectrum with babble noise suppressed. Then inverse Fourier transform may be performed on the obtained spectrum, and a time domain speech signal is reconstructed 908, to implement speech enhancement 909.

In a case that an obtained test result meets an expectation, the intermediate mask estimation model may be used as a target mask estimation model that can be directly used subsequently.

Further, refer to FIG. 10. FIG. 10 is a schematic diagram of noise reduction effect according to an embodiment of this application. As shown in FIG. 10, a spectrum corresponding to a segment of speech that includes babble noise is spectrum 10A in FIG. 10. After noise suppression is performed on the speech with noise by using the method provided in this application and the target mask estimation model, a spectrum corresponding to obtained enhanced speech is spectrum 10B in FIG. 10. It can be learned from comparison between the two spectra that, in the method provided in this application, babble noise can be effectively suppressed while complete speech is retained.

It can be learned from the foregoing descriptions that, in embodiments of this application, the target mask estimation model for outputting a mask corresponding to an audio data frame may be obtained through training on the initial mask estimation model. The model is a lightweight neural network model. This can reduce complexity of calculation during speech enhancement, control the size of an installation package when the model is applied to a scenario, and reduce CPU consumption. In addition, the trained target mask estimation model can automatically and quickly output an estimated mask. This can improve efficiency of speech enhancement on audio data.

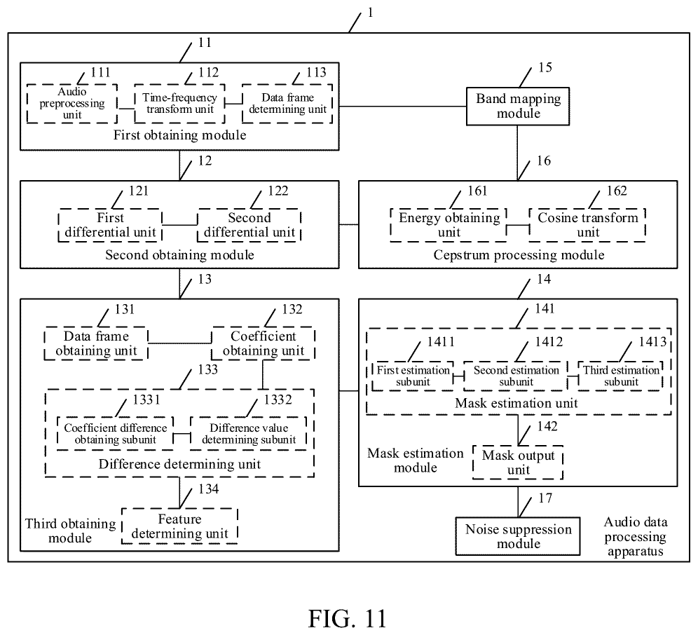

FIG. 11 is a schematic structural diagram of an audio data processing apparatus according to an embodiment of this application. The audio data processing apparatus 1 may be a computer program (including program code) that is run on a computer device. For example, audio data processing apparatus 1 is application software. The apparatus may be configured to perform corresponding steps in the audio data processing method provided in embodiments of this application. As shown in FIG. 11, the audio data processing apparatus 1 may include a first obtaining module 11, a second obtaining module 12, a third obtaining module 13, a mask estimation module 14, a band mapping module 15, a cepstrum processing module 16, and a noise suppression module 17.

The first obtaining module 11 is configured to obtain a target audio data frame and K historical audio data frames that are associated with raw audio data, the target audio data frame and the K historical audio data frames being spectral frames, each of the K historical audio data frames being a spectral frame preceding the target audio data frame, and K being a positive integer.

The first obtaining module 11 may include an audio preprocessing unit 111, a time-frequency transform unit 112, and a data frame determining unit 113.

The audio preprocessing unit 111 is configured to perform framing and windowing preprocessing on the raw audio data to obtain H audio data segments, H being a positive integer greater than 1.

The time-frequency transform unit 112 is configured to perform time-frequency transform on each audio data segment to obtain an audio data frame corresponding to each audio data segment.

In one embodiment, the H audio data segments include an audio data segment i, i being a positive integer less than or equal to H; and

the time-frequency transform unit 112 is specifically configured to: perform Fourier transform on the audio data segment i to obtain a direct-current component frequency bin and 2S frequency bins for the audio data segment i in frequency domain, the 2S frequency bins including S frequency bins related to a first frequency bin type and S frequency bins related to a second frequency bin type, and S being a positive integer; and determine, based on the S frequency bins related to the first frequency bin type and the direct-current component frequency bin, an audio data frame corresponding to the audio data segment i.

The data frame determining unit 113 is configured to determine, from obtained H audio data frames, the target audio data frame and K historical audio data frames preceding the target audio data frame, K being less than H.

In some embodiments, the audio preprocessing unit 111, the time-frequency transform unit 112, and the data frame determining unit 113, refer to step S101 in the embodiment corresponding to FIG. 3. Details are not described herein again.

The second obtaining module 12 is configured to: in a case that N target cepstrum coefficients of the target audio data frame are obtained, obtain, based on the N target cepstrum coefficients, M first-order time derivatives and M second-order time derivatives that are associated with the target audio data frame, N being a positive integer greater than 1, and M being a positive integer less than N.

The second obtaining module 12 may include a first differential unit 121 and a second differential unit 122.

The first differential unit 121 is configured to perform a differential operation on the N target cepstrum coefficients to obtain (N−1) differential operation values, use each of the (N−1) differential operation values as a first-order time derivative, and obtain, from the (N−1) first-order time derivatives, the M first-order time derivatives associated with the target audio data frame.

The second differential unit 122 is configured to perform a secondary differential operation on the (N−1) first-order time derivatives to obtain (N−2) differential operation values, use each of the (N−2) differential operation values as a second-order time derivative, and obtain, from the (N−2) second-order time derivatives, the M second-order time derivatives associated with the target audio data frame.

In some embodiments, first differential unit 121 and the second differential unit 122, refer to step S102 in the embodiment corresponding to FIG. 3. Details are not described herein again.

The third obtaining module 13 is configured to obtain N historical cepstrum coefficients corresponding to each historical audio data frame, and determine, based on obtained K×N historical cepstrum coefficients, a dynamic spectrum feature associated with the target audio data frame.

The third obtaining module 13 may include a data frame obtaining unit 131, a coefficient obtaining unit 132, a difference determining unit 133, and a feature determining unit 134.

The data frame obtaining unit 131 is configured to obtain any two adjacent historical audio data frames from the K historical audio data frames as a first historical audio data frame and a second historical audio data frame, the second historical audio data frame being a spectral frame obtained after the first historical audio data frame.

The coefficient obtaining unit 132 is configured to obtain, from a cache related to the target audio data frame, N historical cepstrum coefficients corresponding to the first historical audio data frame and N historical cepstrum coefficients corresponding to the second historical audio data frame.

The difference determining unit 133 is configured to use N coefficient difference values between the N historical cepstrum coefficients corresponding to the first historical audio data frame and the N historical cepstrum coefficients corresponding to the second historical audio data frame as interframe difference values between the first historical audio data frame and the second historical audio data frame.

The difference determining unit 133 may include: a coefficient difference obtaining subunit 1331 and a difference value determining subunit 1332.

The coefficient difference obtaining subunit 1331 is configured to: obtain a historical cepstrum coefficient Lp from N historical cepstrum coefficients included in first historical cepstrum coefficients, and obtain a historical cepstrum coefficient Lq from N historical cepstrum coefficients included in second historical cepstrum coefficients, p and q being positive integers less than or equal to N, and p=q; and obtain a coefficient difference value between the historical cepstrum coefficient Lp and the historical cepstrum coefficient Lq.

The difference value determining subunit 1332 is configured to determine band difference values between the first historical cepstrum coefficients and the second historical cepstrum coefficients based on coefficient difference values, and use the band difference values as interframe difference values between the first historical audio data frame and the second historical audio data frame.

In some embodiments, the coefficient difference obtaining subunit 1331 and the difference value determining subunit 1332, refer to step S103 in the embodiment corresponding to FIG. 3. Details are not described herein again.

The feature determining unit 134 is configured to determine the dynamic spectrum feature associated with the target audio data frame based on K−1 interframe difference values between adjacent historical audio data frames in the K historical audio data frames.

In some embodiments, the data frame obtaining unit 131, the coefficient obtaining unit 132, the difference determining unit 133, and the feature determining unit 134, refer to step S103 in the embodiment corresponding to FIG. 3. Details are not described herein again.

The mask estimation module 14 is configured to input the N target cepstrum coefficients, the M first-order time derivatives, the M second-order time derivatives, and the dynamic spectrum feature to a target mask estimation model, the target mask estimation model outputting a target mask corresponding to the target audio data frame, and the target mask being used for suppressing noise data in the raw audio data to obtain enhanced audio data corresponding to the raw audio data.

In one embodiment, the target mask estimation model includes a mask estimation network layer and a mask output layer; and the mask estimation module 14 may include a mask estimation unit 141 and a mask output unit 142.

The mask estimation unit 141 is configured to use the N target cepstrum coefficients, the M first-order time derivatives, the M second-order time derivatives, and the dynamic spectrum feature as a target audio feature of the target audio data frame, and input the target audio feature to the mask estimation network layer, the mask estimation network layer performing mask estimation on the target audio feature to obtain a hidden feature corresponding to the target audio feature.

In one embodiment, the mask estimation network layer includes a first mask estimation network layer, a second mask estimation network layer, and a third mask estimation network layer that have a skip connection; and the mask estimation unit 141 may include a first estimation subunit 1411, a second estimation subunit 1412, and a third estimation subunit 1413.

The first estimation subunit 1411 is configured to input the target audio feature to the first mask estimation network layer, the first mask estimation network layer outputting a first intermediate feature.

The second estimation subunit 1412 is configured to perform feature splicing on the first intermediate feature and the target audio feature based on a skip connection between the first mask estimation network layer and the second mask estimation network layer to obtain a second intermediate feature, and input the second intermediate feature to the second mask estimation network layer, the second mask estimation network layer outputting a third intermediate feature.

The third estimation subunit 1413 is configured to perform feature splicing on the third intermediate feature, the target audio feature, and the first intermediate feature based on a skip connection between the first mask estimation network layer and the third mask estimation network layer, and a skip connection between the second mask estimation network layer and the third mask estimation network layer, to obtain a fourth intermediate feature; and input the fourth intermediate feature to the third mask estimation network layer, the third mask estimation network layer outputting the hidden feature corresponding to the target audio feature.

In some embodiments, the first estimation subunit 1411, the second estimation subunit 1412, and the third estimation subunit 1413, refer to step S104 in the embodiment corresponding to FIG. 3. Details are not described herein again.

The mask output unit 142 is configured to input the hidden feature to the mask output layer, the mask output layer performing feature combination on the hidden feature to obtain the target mask corresponding to the target audio data frame.

In some embodiments, the mask estimation unit 141 and the mask output unit 142, refer to step S104 in the embodiment corresponding to FIG. 3. Details are not described herein again.

In one embodiment, the target audio data frame includes S1 frequency bins, the S1 frequency bins include a direct-current component frequency bin and S2 frequency bins related to a frequency bin type, and both S1 and S2 are positive integers;
the band mapping module 15 is configured to map the S1 frequency bins to N acoustic bands, S1 being greater than or equal to N; and
the cepstrum processing module 16 is configured to perform cepstrum processing on each acoustic band to obtain a target cepstrum coefficient corresponding to each acoustic band.

In one embodiment, the N acoustic bands include an acoustic band j, j being a positive integer less than or equal to N; and
the cepstrum processing module 16 may include an energy obtaining unit 161 and a cosine transform unit 162.

The energy obtaining unit 161 is configured to obtain band energy of the acoustic band j, and perform logarithmic transform on the band energy of the acoustic band j to obtain logarithmic band energy of the acoustic band j.

The cosine transform unit 162 is configured to perform discrete cosine transform on the logarithmic band energy of the acoustic band j to obtain a target cepstrum coefficient corresponding to the acoustic band j.

In some embodiments, the energy obtaining unit 161 and the cosine transform unit 162, refer to step S102 in the embodiment corresponding to FIG. 3. Details are not described herein again.

The noise suppression module 17 is configured to: perform interpolation on the target mask to obtain an interpolation mask, a length of the interpolation mask being the same as that of the target audio data frame; multiply the interpolation mask with the target audio data frame, and perform inverse Fourier transform on a multiplication result to obtain target audio data that is obtained by performing noise suppression on the target audio data frame; and after noise suppression is performed on each audio data frame associated with the raw audio data, obtain, based on target audio data corresponding to each audio data frame, enhanced audio data corresponding to the raw audio data.

In some embodiments, the first obtaining module 11, the second obtaining module 12, the third obtaining module 13, the mask estimation module 14, the band mapping module 15, the cepstrum processing module 16, and the noise suppression module 17, refer to step S101 to step S104 in the embodiment corresponding to FIG. 3. Details are not described herein again. In addition, the description of beneficial effects of the same method are not described herein again.

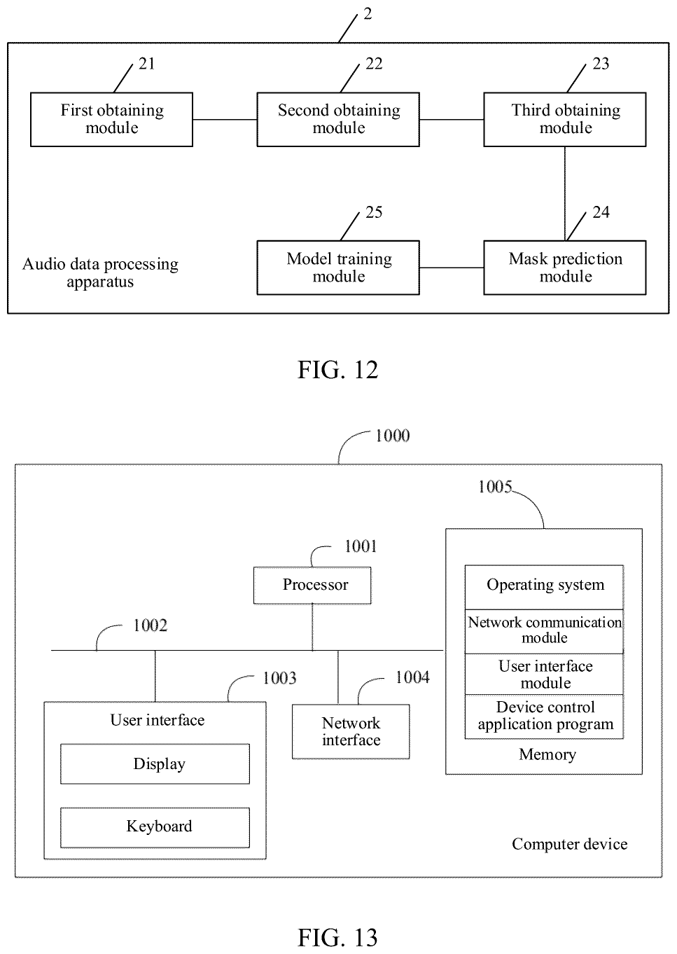

FIG. 12 is a schematic structural diagram of an audio data processing apparatus according to an embodiment of this application. The audio data processing apparatus 2 may be a computer program (including program code) that is run on a computer device. For example, audio data processing apparatus 2 is application software. The apparatus may be configured to perform corresponding steps in the audio data processing method provided in embodiments of this application. As shown in FIG. 12, the audio data processing apparatus 2 may include a first obtaining module 21, a second obtaining module 22, a third obtaining module 23, a mask prediction module 24, and a model training module 25.

The first obtaining module 21 is configured to obtain a target sample audio data frame and K historical sample audio data frames that are associated with sample audio data, and obtain a sample mask corresponding to the target sample audio data frame, the target sample audio data frame and the K historical sample audio data frames being spectral frames, each of the K historical sample audio data frames being a spectral frame preceding the target sample audio data frame, and K being a positive integer.

The second obtaining module 22 is configured to: in a case that N target sample cepstrum coefficients of the target sample audio data frame are obtained, obtain, based on the N target sample cepstrum coefficients sample, M sample first-order time derivatives and M sample second-order time derivatives that are associated with the target sample audio data frame, N being a positive integer greater than 1, and M being a positive integer less than N.

The third obtaining module 23 is configured to obtain N historical sample cepstrum coefficients corresponding to each historical sample audio data frame, and determine, based on obtained K×N historical sample cepstrum coefficients, a sample dynamic spectrum feature associated with the target sample audio data frame.

The mask prediction module 24 is configured to input the N target sample cepstrum coefficients, the M sample first-order time derivatives, the M sample second-order time derivatives, and the sample dynamic spectrum feature to an initial mask estimation model, the initial mask estimation model outputting a predicted mask corresponding to the target sample audio data frame.

The model training module 25 is configured to perform iterative training on the initial mask estimation model based on the predicted mask and the sample mask to obtain a target mask estimation model, the target mask estimation model being used for outputting a target mask corresponding to a target audio data frame associated with raw audio data, and the target mask being used for suppressing noise data in the raw audio data to obtain enhanced audio data corresponding to the raw audio data.

In some embodiments, the first obtaining module 21, the second obtaining module 22, the third obtaining module 23, the mask prediction module 24, and the model training module 25, refer to step S201 to step S205 in the embodiment corresponding to FIG. 8. Details are not described herein again. In addition, the description of beneficial effects of the same method are not described herein again.

FIG. 13 is a schematic structural diagram of a computer device according to an embodiment of this application. As shown in FIG. 13, the computer device 1000 may include: a processor 1001, a network interface 1004, and a memory 1005. In addition, the computer device 1000 may further include a user interface 1003 and at least one communications bus 1002. The communications bus 1002 is configured to implement connection and communication between these components. The user interface 1003 may include a display and a keyboard. In some embodiments, the user interface 1003 may further include a standard wired interface and a standard wireless interface. The network interface 1004 may include a standard wired interface and wireless interface (for example, a Wi-Fi interface). Memory 1005 may be a high-speed RAM memory, or may be a non-volatile memory, for example, at least one magnetic disk memory. In some embodiments, memory 1005 may be at least one storage apparatus located away from the processor 1001. As shown in FIG. 13, memory 1005 used as a computer-readable storage medium may include an operating system, a network communication module, a user interface module, and a device-control application program.

In the computer device 1000 shown in FIG. 13, the network interface 1004 may provide a network communication function, the user interface 1003 is mainly configured to provide an input interface for a user, and the processor 1001 may be configured to invoke the device-control application program stored in the memory 1005 to perform the descriptions of the audio data processing method in the embodiment corresponding to either of FIG. 3 and FIG. 8. In addition, the description of beneficial effects of the same method are not described herein again.

Embodiments of this application further provide a computer-readable storage medium. The computer-readable storage medium stores a computer program to be executed by the audio data processing apparatus 1 and the audio data processing apparatus 2, and the computer program includes program instructions. When the program instructions are executed by a processor, the descriptions of the audio data processing method in the embodiment corresponding to either of FIG. 3 or FIG. 8 can be performed. Therefore, details are not described herein again. In addition, the description of beneficial effects of the same method are not described herein again. For technical details that are not disclosed in the computer-readable storage medium embodiments of this application, refer to the descriptions of the method embodiments of this application.

The computer-readable storage medium may be an internal storage unit of the audio data processing apparatus provided in any one of the foregoing embodiments or the computer device in any one of the foregoing embodiments, for example, a hard disk drive or a memory of the computer device. Alternatively, the computer-readable storage medium may be an external storage device of the computer device, for example, a plug-in hard disk, a smart media card (SMC), a secure digital (SD) card, a flash card, or the like that is configured on the computer device. Further, the computer-readable storage medium may alternatively include both an internal storage unit of the computer device and an external storage device. The computer-readable storage medium is configured to store the computer program and other programs and data that are required by the computer device. The computer-readable storage medium may be further configured to temporarily store data that has been output or is to be output.

Embodiments of this application further provide a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, so that the computer device performs the method provided in the embodiment corresponding to either of FIG. 3 or FIG. 8. In addition, the description of beneficial effects of the same method are not described herein again. For technical details that are not disclosed in the computer program product or computer program embodiments of this application, refer to the descriptions of the method embodiments of this application.

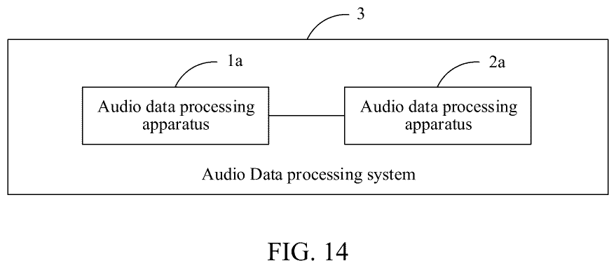

Further, FIG. 14 is a schematic structural diagram of an audio data processing system according to an embodiment of this application. The audio data processing system 3 may include an audio data processing apparatus 1a and an audio data processing apparatus 2a.

The audio data processing apparatus 1a may be the audio data processing apparatus 1 in the embodiment corresponding to FIG. 11. It can be understood that the audio data processing apparatus 1a may be integrated in computer device 20 in the embodiment corresponding to FIG. 2. Therefore, details are not described herein again.

The audio data processing apparatus 2a may be the audio data processing apparatus 2 in the embodiment corresponding to FIG. 12. It can be understood that the audio data processing apparatus 2a may be integrated in computer device 20 in the embodiment corresponding to FIG. 2. Therefore, details are not described herein again.

In addition, the description of beneficial effects of the same method are not described herein again. For technical details that are not disclosed in the audio data processing system embodiments of this application, refer to the descriptions of the method embodiments of this application.

In the specification, claims, and accompanying drawings of embodiments of this application, the terms “first”, “second”, and the like are merely intended to distinguish between different objects but do not indicate a particular order. In addition, the term “include” and any variants thereof are intended to cover a non-exclusive inclusion. For example, a process, a method, an apparatus, a product, or a device that includes a series of steps or units is not limited to the listed steps or modules, but may further include other unlisted steps or modules, or may further include other inherent steps or units of the process, the method, the apparatus, the product, or the device.

A person of ordinary skill in the art may be aware that, in combination with the examples described in embodiments disclosed in this specification, units and algorithm steps can be implemented by electronic hardware, computer software, or a combination thereof. To clearly describe interchangeability between hardware and software, the foregoing generally describes compositions and steps of the examples based on functions. Whether the functions are performed by hardware or software depends on particular applications and design constraints of technical solutions. A person skilled in the art may use different methods to implement the described functions for each particular application, but it is not to be considered that the implementation goes beyond the scope of this application.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. An audio data processing method, performed by a computer device and comprising:
obtaining a target audio data frame and K historical audio data frames that are associated with raw audio data, the target audio data frame and the K historical audio data frames being spectral frames, each of the K historical audio data frames being a spectral frame preceding the target audio data frame, and K being a positive integer;
in a case that N target cepstrum coefficients of the target audio data frame are obtained, obtaining, based on the N target cepstrum coefficients, M first-order time derivatives and M second-order time derivatives that are associated with the target audio data frame, N being a positive integer greater than 1, and M being a positive integer less than N;
obtaining N historical cepstrum coefficients corresponding to each historical audio data frame, and determining, based on obtained K×N historical cepstrum coefficients, a dynamic spectrum feature associated with the target audio data frame; and
inputting the N target cepstrum coefficients, the M first-order time derivatives, the M second-order time derivatives, and the dynamic spectrum feature into a target mask estimation model to obtain a target mask corresponding to the target audio data frame; and
applying the target mask to obtain enhanced audio data corresponding to the raw audio data by suppressing noise data in the raw audio data.

2. The method according to claim 1, wherein the obtaining a target audio data frame and K historical audio data frames that are associated with raw audio data comprises:
performing framing and windowing preprocessing on the raw audio data to obtain H audio data segments, H being a positive integer greater than 1;
performing time-frequency transform on each audio data segment to obtain an audio data frame corresponding to each audio data segment; and
determining, from obtained H audio data frames, the target audio data frame and K historical audio data frames preceding the target audio data frame, K being less than H.

3. The method according to claim 2, wherein the H audio data segments comprise an audio data segment i, i being a positive integer less than or equal to H; and
the performing time-frequency transform on each audio data segment to obtain an audio data frame corresponding to each audio data segment comprises:
performing Fourier transform on the audio data segment i to obtain a direct-current component frequency bin and 2S frequency bins for the audio data segment i in frequency domain, the 2S frequency bins comprising S frequency bins related to a first frequency bin type and S frequency bins related to a second frequency bin type, and S being a positive integer; and
determining an audio data frame corresponding to the audio data segment i based on the S frequency bins related to the first frequency bin type and the direct-current component frequency bin.

4. The method according to claim 1, wherein the target audio data frame comprises S1 frequency bins, the S1 frequency bins comprise a direct-current component frequency bin and S2 frequency bins related to a frequency bin type, and both S1 and S2 are positive integers; and the obtaining of the N target cepstrum coefficients of the target audio data frame comprises:
mapping the S1 frequency bins to N acoustic bands, S1 being greater than or equal to N; and
performing cepstrum processing on each acoustic band to obtain a target cepstrum coefficient corresponding to each acoustic band.

5. The method according to claim 4, wherein the N acoustic bands comprise an acoustic band j, j being a positive integer less than or equal to N; and
the performing cepstrum processing on each acoustic band to obtain a target cepstrum coefficient corresponding to each acoustic band comprises:
obtaining band energy of the acoustic band j, and performing logarithmic transform on the band energy of the acoustic band j to obtain logarithmic band energy of the acoustic band j; and
performing discrete cosine transform on the logarithmic band energy of the acoustic band j to obtain a target cepstrum coefficient corresponding to the acoustic band j.

6. The method according to claim 1, wherein the obtaining, based on the N target cepstrum coefficients, M first-order time derivatives and M second-order time derivatives that are associated with the target audio data frame comprises:
performing a differential operation on the N target cepstrum coefficients to obtain (N−1) differential operation values, using each of the (N−1) differential operation values as a first-order time derivative, and obtaining, from the (N−1) first-order time derivatives, the M first-order time derivatives associated with the target audio data frame; and
performing a secondary differential operation on the (N−1) first-order time derivatives to obtain (N−2) differential operation values, using each of the (N−2) differential operation values as a second-order time derivative, and obtaining, from the (N−2) second-order time derivatives, the M second-order time derivatives associated with the target audio data frame.

7. The method according to claim 1, wherein the obtaining N historical cepstrum coefficients corresponding to each historical audio data frame comprises:
obtaining any two adjacent historical audio data frames from the K historical audio data frames as a first historical audio data frame and a second historical audio data frame, the second historical audio data frame being a spectral frame obtained after the first historical audio data frame; and
obtaining, from a cache related to the target audio data frame, N historical cepstrum coefficients corresponding to the first historical audio data frame and N historical cepstrum coefficients corresponding to the second historical audio data frame.

8. The method according to claim 7, wherein the determining, based on obtained K×N historical cepstrum coefficients, a dynamic spectrum feature associated with the target audio data frame comprises:
using N coefficient difference values between the N historical cepstrum coefficients corresponding to the first historical audio data frame and the N historical cepstrum coefficients corresponding to the second historical audio data frame as interframe difference values between the first historical audio data frame and the second historical audio data frame; and
determining the dynamic spectrum feature associated with the target audio data frame based on K−1 interframe difference values between adjacent historical audio data frames in the K historical audio data frames.

9. The method according to claim 1, wherein the target mask estimation model comprises a mask estimation network layer and a mask output layer; and
the inputting the N target cepstrum coefficients, the M first-order time derivatives, the M second-order time derivatives, and the dynamic spectrum feature to a target mask estimation model, the target mask estimation model outputting a target mask corresponding to the target audio data frame comprises:
using the N target cepstrum coefficients, the M first-order time derivatives, the M second-order time derivatives, and the dynamic spectrum feature as a target audio feature of the target audio data frame, inputting the target audio feature to the mask estimation network layer, and performing, by the mask estimation network layer, mask estimation on the target audio feature to obtain a hidden feature corresponding to the target audio feature; and
inputting the hidden feature to the mask output layer, and performing, by the mask output layer, feature combination on the hidden feature to obtain the target mask corresponding to the target audio data frame.

10. The method according to claim 9, wherein the mask estimation network layer comprises a first mask estimation network layer, a second mask estimation network layer, and a third mask estimation network layer that have a skip connection; and
the inputting the target audio feature to the mask estimation network layer, and performing, by the mask estimation network layer, mask estimation on the target audio feature to obtain a hidden feature corresponding to the target audio feature comprises:
inputting the target audio feature to the first mask estimation network layer, the first mask estimation network layer outputting a first intermediate feature;
performing feature splicing on the first intermediate feature and the target audio feature based on a skip connection between the first mask estimation network layer and the second mask estimation network layer to obtain a second intermediate feature, inputting the second intermediate feature to the second mask estimation network layer, the second mask estimation network layer outputting a third intermediate feature;
performing feature splicing on the third intermediate feature, the target audio feature, and the first intermediate feature based on a skip connection between the first mask estimation network layer and the third mask estimation network layer, and a skip connection between the second mask estimation network layer and the third mask estimation network layer, to obtain a fourth intermediate feature; and
inputting the fourth intermediate feature to the third mask estimation network layer, the third mask estimation network layer outputting the hidden feature corresponding to the target audio feature.

11. The method according to claim 1, further comprising:
performing interpolation on the target mask to obtain an interpolation mask, a length of the interpolation mask being the same as that of the target audio data frame;
multiplying the interpolation mask with the target audio data frame, and performing inverse Fourier transform on a multiplication result to obtain target audio data that is obtained by performing noise suppression on the target audio data frame; and
after noise suppression is performed on each audio data frame associated with the raw audio data, obtaining, based on target audio data corresponding to each audio data frame, enhanced audio data corresponding to the raw audio data.

12. An audio data processing method, performed by a computer device and comprising:
obtaining a target sample audio data frame and K historical sample audio data frames that are associated with sample audio data, and obtaining a sample mask corresponding to the target sample audio data frame, the target sample audio data frame and the K historical sample audio data frames being spectral frames, each of the K historical sample audio data frames being a spectral frame preceding the target sample audio data frame, and K being a positive integer;
in a case that N target sample cepstrum coefficients of the target sample audio data frame are obtained, obtaining, based on the N target sample cepstrum coefficients sample, M sample first-order time derivatives and M sample second-order time derivatives that are associated with the target sample audio data frame, N being a positive integer greater than 1, and M being a positive integer less than N;
obtaining N historical sample cepstrum coefficients corresponding to each historical sample audio data frame, and determining, based on obtained K×N historical sample cepstrum coefficients, a sample dynamic spectrum feature associated with the target sample audio data frame;
inputting the N target sample cepstrum coefficients, the M sample first-order time derivatives, the M sample second-order time derivatives, and the sample dynamic spectrum feature to an initial mask estimation model, the initial mask estimation model outputting a predicted mask corresponding to the target sample audio data frame; and
performing iterative training on the initial mask estimation model based on the predicted mask and the sample mask to obtain a target mask estimation model, the target mask estimation model outputting a target mask corresponding to a target audio data frame associated with raw audio data, and the target mask being used for suppressing noise data in the raw audio data to obtain enhanced audio data corresponding to the raw audio data.

13. A computer device, comprising: a processor and a memory,
the processor being connected to the memory, the memory being configured to store a computer program, and the processor being configured to invoke the computer program, so that the computer device performs an audio data processing method, comprising:
obtaining a target audio data frame and K historical audio data frames that are associated with raw audio data, the target audio data frame and the K historical audio data frames being spectral frames, each of the K historical audio data frames being a spectral frame preceding the target audio data frame, and K being a positive integer;
in a case that N target cepstrum coefficients of the target audio data frame are obtained, obtaining, based on the N target cepstrum coefficients, M first-order time derivatives and M second-order time derivatives that are associated with the target audio data frame, N being a positive integer greater than 1, and M being a positive integer less than N;
obtaining N historical cepstrum coefficients corresponding to each historical audio data frame, and determining, based on obtained K×N historical cepstrum coefficients, a dynamic spectrum feature associated with the target audio data frame; and
inputting the N target cepstrum coefficients, the M first-order time derivatives, the M second-order time derivatives, and the dynamic spectrum feature into a target mask estimation model to obtain a target mask corresponding to the target audio data frame; and
applying the target mask to obtain enhanced audio data corresponding to the raw audio data by suppressing noise data in the raw audio data.

14. The computer device according to claim 13, wherein the obtaining a target audio data frame and K historical audio data frames that are associated with raw audio data comprises:
performing framing and windowing preprocessing on the raw audio data to obtain H audio data segments, H being a positive integer greater than 1;
performing time-frequency transform on each audio data segment to obtain an audio data frame corresponding to each audio data segment; and
determining, from obtained H audio data frames, the target audio data frame and K historical audio data frames preceding the target audio data frame, K being less than H.

15. The computer device according to claim 14, wherein the H audio data segments comprise an audio data segment i, i being a positive integer less than or equal to H; and
the performing time-frequency transform on each audio data segment to obtain an audio data frame corresponding to each audio data segment comprises:
performing Fourier transform on the audio data segment i to obtain a direct-current component frequency bin and 2S frequency bins for the audio data segment i in frequency domain, the 2S frequency bins comprising S frequency bins related to a first frequency bin type and S frequency bins related to a second frequency bin type, and S being a positive integer; and
determining an audio data frame corresponding to the audio data segment i based on the S frequency bins related to the first frequency bin type and the direct-current component frequency bin.

16. The computer device according to claim 13, wherein the target audio data frame comprises S1 frequency bins, the S1 frequency bins comprise a direct-current component frequency bin and S2 frequency bins related to a frequency bin type, and both S1 and S2 are positive integers; and the obtaining of the N target cepstrum coefficients of the target audio data frame comprises:
mapping the S1 frequency bins to N acoustic bands, S1 being greater than or equal to N; and
performing cepstrum processing on each acoustic band to obtain a target cepstrum coefficient corresponding to each acoustic band.

17. The computer device according to claim 16, wherein the N acoustic bands comprise an acoustic band j, j being a positive integer less than or equal to N; and
the performing cepstrum processing on each acoustic band to obtain a target cepstrum coefficient corresponding to each acoustic band comprises:
obtaining band energy of the acoustic band j, and performing logarithmic transform on the band energy of the acoustic band j to obtain logarithmic band energy of the acoustic band j; and
performing discrete cosine transform on the logarithmic band energy of the acoustic band j to obtain a target cepstrum coefficient corresponding to the acoustic band j.

18. The computer device according to claim 13, wherein the obtaining, based on the N target cepstrum coefficients, M first-order time derivatives and M second-order time derivatives that are associated with the target audio data frame comprises:
performing a differential operation on the N target cepstrum coefficients to obtain (N−1) differential operation values, using each of the (N−1) differential operation values as a first-order time derivative, and obtaining, from the (N−1) first-order time derivatives, the M first-order time derivatives associated with the target audio data frame; and
performing a secondary differential operation on the (N−1) first-order time derivatives to obtain (N−2) differential operation values, using each of the (N−2) differential operation values as a second-order time derivative, and obtaining, from the (N−2) second-order time derivatives, the M second-order time derivatives associated with the target audio data frame.

19. The computer device according to claim 13, wherein the obtaining N historical cepstrum coefficients corresponding to each historical audio data frame comprises:
obtaining any two adjacent historical audio data frames from the K historical audio data frames as a first historical audio data frame and a second historical audio data frame, the second historical audio data frame being a spectral frame obtained after the first historical audio data frame; and
obtaining, from a cache related to the target audio data frame, N historical cepstrum coefficients corresponding to the first historical audio data frame and N historical cepstrum coefficients corresponding to the second historical audio data frame.

20. The computer device according to claim 19, wherein the determining, based on obtained K×N historical cepstrum coefficients, a dynamic spectrum feature associated with the target audio data frame comprises:
using N coefficient difference values between the N historical cepstrum coefficients corresponding to the first historical audio data frame and the N historical cepstrum coefficients corresponding to the second historical audio data frame as interframe difference values between the first historical audio data frame and the second historical audio data frame; and
determining the dynamic spectrum feature associated with the target audio data frame based on K−1 interframe difference values between adjacent historical audio data frames in the K historical audio data frames.
